(19) United States
(12) Patent Application Publication
(10) Pub. No.: US 2014/0358505 A1
(43) Pub. Date: Dec. 4, 2014

(54) COLLISION IMPULSE DERIVED DISCRETE ELEMENT CONTACT FORCE DETERMINATION ENGINE, METHOD, SOFTWARE AND SYSTEM

(71) Applicant: THE BOARD OF TRUSTEES OF THE UNIVERSITY OF ILLINOIS, URBANA, IL (US)

(72) Inventors: Youssef M.A. Hashash, Urbana, IL (US); Seung Jae Lee, Savoy, IL (US); Jamshid Ghaboussi, Urbana, IL (US)

(21) Appl. No.: 14/285,947

(22) Filed: May 23, 2014

Related U.S. Application Data
(60) Provisional application No. 61/829,481, filed on May 31, 2013.

(51) Int. Cl. G06F 17/50; G06F 17/17

(52) U.S. Cl. CPC G06F 17/5009; G06F 17/17
USPC 703/2; 703/6

(57) ABSTRACT

A method and engine for simulating a multi-body system, the method or engine including code for determining collision impulse over a time period for a plurality of colliding bodies in the system. An admissible function is determined from the collision impulse and resembles true contact force from the collision impulse. Complete contact force change during collision is derived from the admissible function.

### PRIORITY CLAIM AND REFERENCE TO RELATED APPLICATION

This application claims priority under 35 U.S.C. §119 from prior provisional application Ser. No. 61/829,481, which was filed May 31, 2013.

### FIELD

A field of the invention is physics based simulation engines. The invention is particularly applicable to systems requiring engineering accuracy in simulating the interaction of bodies including large scale simulations of granular materials. Additional example applications of the invention include physics based engines in video game systems, computer-animated film systems, virtual prototyping systems, haptic simulation systems, and other systems that determine interaction of discrete bodies.

### BACKGROUND

Granular material is ubiquitous in nature and industry. It is encountered and needs to be characterized in a number of engineering disciplines. Examples include construction, agriculture, aerospace, and the pharmaceutical industry. Granular material is complex to model because it is neither completely solid nor completely fluid. Therefore, discontinuum-based numerical approaches are widely employed to simulate the granular materials. These approaches commonly model the granular material as a discrete system in which each particle is modeled as an individual rigid or deformable element to explicitly account for particle interactions and associated energy dissipation, which is not considered in the continuum mechanics frameworks such as the finite element method (FEM).

Many systems seek to simulate the interaction of discrete bodies. The interaction of such bodies creates complex contact forces that are complex to model/simulate. The code, firmware and/or hardware that simulates the motion of bodies based on a set of physics law are engines or simulators. Generally, these engines are computer software stored on a non-transient medium which can plausibly simulate a multi-body system by controlling a computer based on the physics laws.

Different types of engines have been developed to simulate the interaction of discrete bodies. Many common applications provide plausible visual results without requiring determination of contact forces, typically based on collision impulse-velocity based engines. This type of computer code has been widely developed and used in a wide variety of areas, including, for example, video games and computer-animated films.

In this approach, the primary variables are impulse, which is the time integral of forces (equivalent to the change in momentum) as shown in equation (1), and velocity. The simulation of discrete bodies involves collisions between bodies, so it is called collision impulse, which is again the integral of the contact force during collision period (Δt_{c}).

ι=∫₀^{Δt}^{_{c}}ƒ(t)dt (1)

Other applications require explicit calculation of contact forces. These applications include, for example, virtual prototyping, geotechnical applications, pharmaceutical plant process design, and most any application requiring an engineering level of accuracy. Particular applications include systems that have to simulate the interaction of granular materials. Contact force-acceleration based engines are typically used in these applications that require an engineering level of accuracy and force information.

Many contact force-acceleration engines developed to determine the interaction of discrete bodies have roots in the Discrete Element Method (DEM) that originated with Cundall and Strack. See, Cundall and Strack, “A discrete numerical model for granular assemblies.” Geotechnique 29(1): 47-65 (1979). The original development of DEM was made for spherical or ellipsoidal particles. In such methods, each particle is modeled as a circular 2D disk, and the interaction of particles are controlled by springs and dampers modeled between them, i.e., a mass-spring-damper system. The central difference scheme is used to explicitly integrate the 2nd order differential equation of motion. Overlap between particles is used to determine the contact force via Hooke's law. The force is then used to calculate new acceleration for the motion update with Newton's second law, i.e., a contact force-acceleration based dynamics. A new velocity can be found from the integration of the acceleration and a new position of each body is then obtained via a second integration of the velocity, which is known as 2^{nd} order explicit time integration of motion.

Despite significant algorithmic performance and accuracy enhancements since the inception, DEM remains a computationally expensive numerical method when applied to simulate granular materials. For complex granular multi-body systems, the time required for calculations on modern day super-computing systems can render simulation impractical. The collision impulse-velocity based simulation methods have significant code speed advantages but lack the required accuracy necessary for engineering applications.

The tradeoffs between accuracy and code speed in approaches have resulted in the divergent development and application of the collision impulse and contact force methods. The contact force-acceleration engines are widely recognized to emphasize accuracy over speed. The collision impulse-velocity engines are widely recognized to emphasize speed by sacrificing contact force information.

The collision impulse-velocity engines are used when the code speed and numerical stability are of critical importance for real-time human and machine interaction and stable code performance. Video games are an important example application that utilizes these engines. These engines use the collision impulse as the primary variable, which is the integration of contact force during the collision time by definition. Therefore, integration of acceleration level is avoided, and collision impulse directly changes particle velocity, which makes instantaneous motion updates possible without consideration of acceleration. Further calculation expenses can be saved with use of a large time step for the simulation. However, compared to the contact force acceleration class of engines, the collision impulse-velocity engines sacrifice contact force information, rendering the engines unsuitable for any application that require a higher order resolution.

The contact force-acceleration engines are applied when accuracy with code stability is more important than speed. This includes codes in the computational science and engineering field, which place great emphasis on the engineering accuracy. These codes generally run extremely slowly on a personal computer, so such large scale DEM contact force based simulations can run, for example, for several months to simulate a million polyhedral particles even on a powerful workstation. Supercomputers may be adopted to simulate such a large scale problem. However, such computing resources are only accessible by very limited numbers of academic researchers in select research institutions. This computational complexity limits usage in practice. The time scale required for the simulations also limits applicability.

The computational expense of DEM increases more with consideration of realistic polyhedral particles to provide increased accuracy of quantitative prediction, as it requires an expensive geometric test for contact detection. Significant algorithmic developments for faster particle contact detection include the Shortest Link method. See, Nezami, Hashash, Zhao and Ghaboussi, “Shortest link method for contact detection in discrete element method,” International Journal for Numerical and Analytical Methods in Geomechanics, Vol. 30, No. 8, pp 783-80 (2006), and for its application, Nezami, Hashash, Zhao, and Ghaboussi “Simulation of front end loader bucket-soil interaction using discrete element method,” International Journal for Numerical and Analytical Methods in Geomechanics, Vol. 31, No. 9, pp. 1147-62 (2007).

Despite algorithmic improvements, the DEM simulation is still constrained by the use of micro-time steps (Δt) that significantly increase computational costs. The time step to be used in a DEM simulation is limited by a critical time step for numerical stability and is controlled by the highest natural frequency of the discrete system calculated from the minimum particle mass, and the normal contact stiffness. The time step is also typically much smaller than the collision period (Δt_{c}) between the particles, which is already a very short time period. See, Zhao, Nezami, Hashash, and Ghaboussi, “Three-dimensional discrete element simulation for granular materials,” Engineering Computations, Vol. 23, No. 7, pp. 749-70 (2006). The size of the particles in a simulation affects both the time step and the total number of particles that can be simulated. The stiff spring modeled between particles introduces numerical instability in DEM with use of a large time step. Therefore, any contact in the system for a single time step should remain small enough, compared to the particle size. In this way, the typical time step used in DEM simulation is 10⁻⁴˜10⁻⁷ sec. When this is coupled with needed double-precision floating-point arithmetic, significant computational costs result, which are excessive for widespread practical use.

Geotechnical DEM simulations often treat deformation of each particle as negligible, but inter-particular penetration is indirectly considered as deformation. To simulate rigidity of the particles, high contact stiffness is utilized, but this yields an even smaller time step, which thus produces an even longer run-time.

Compared to DEM, collision impulse based approaches have a number of advantages in terms of complexity and speed. Collision impulse requires no modeling of a stiff spring between objects in collision, which causes the numerical instability. Integration of acceleration level is skipped, while velocity is handled directly to update motion, i.e., the first order time integration. Collision impulse is used to separate objects that collide instead of contact force. Large time steps can be used. For example, a number of plausible game engines utilize a step of 1/60 sec. Single precision implementations are possible without numerical stability issues and the code is therefore suitable for implementation on low memory devices, such as personal computers, game consoles, and portable computer devices.

There are two categories of impulse methods: the simultaneous collision model and the propagation collision model, which is also referred to as the sequential impulse model. The simultaneous collision model handles the impulse for the all contact points at the same time. The propagation model computes and applies the impulse on each contact point as series of individual collisions. In the propagation model, the solver iterates over every contact point until the specified collision law is numerically satisfied for all of contact points. It is not appropriate to conclude which method is more accurate than the other because there are certain circumstances one model better suits than the other. See, Smith, Kaufman, Vouga, Tamstorf, Grinspun, “Reflections on simultaneous impact,” ACM Transactions on Graphics (Proceedings of SIGGRAPH 2012), Vol. 31, No. 4, pp 106:101-106:112.

Recently, the propagation collision model is more often used due to its implementation simplicity, especially in the game engine community. In contrast, the simultaneous collision model is formulated via a LCP (Linear Complementary Problem) approach. In an LCP approach, the corresponding set of impulses are found and applied simultaneously by solving the system equations. This creates mathematical complexity and requires a programmer having knowledge in mathematical programming for implementation. Another issue with LCP is that non-contemporaneous collisions occur are considered as simultaneous with use of a large time step. Compared to LCP, the propagation collision model provides a simpler formulation and corresponding code implementation. Calculating the impulse of a single contact point between two particles is mathematically straightforward. Coding also requires simple implementation of a local collision solver between two particles and some iteration statements. No large system of equations is formed and a programmer not conversant in numerical programming can formulate the code without much difficulty. The simplicity and efficiency of the propagation collision model has resulted in the use of the model in numerous popular video games and animated films.

Development of the contact force-acceleration engines has been separate from the impulse-velocity engines. Researchers working on the DEM-like methods have generally sought to improve accuracy while focusing on using realistic shapes and sizes of particles, and also provide better performance on the neighbor search and contact detection. Researchers have focused upon using parallel processing capabilities of shared and distributed supercomputer systems, although such resources are generally not available to the field practitioners. Researchers have generally assumed that computing power would soon catch up with the demands of contact force-acceleration DEM, but the clock speed of a CPU core is still remaining close to 3 GHz over recent years.

Prior to the invention, development of collision-impulse engines for gaming and animation would have likely continued on the separate path from contact force-acceleration engine development for engineering type applications. DEM-like contact force-acceleration engines and applications would have remained separate and distinct from impulse-velocity engines and applications. Artisans use collision impulse methods for speed. DEM developers view the collision impulse engines as lacking critical higher-order details, such as contact force, that are necessary for the most engineering applications.

### SUMMARY OF THE INVENTION

A method and engine for simulating a multi-body system, the method or engine including code for determining collision impulse over a time period for a plurality of colliding bodies in the system. An admissible function is determined from the collision impulse and resembles true contact force from the collision impulse. Complete contact force change during collision is derived from the admissible function.

### BRIEF DESCRIPTION OF THE DRAWINGS

FIGS. 1A and 1B plot an example change of the normal component of contact force, collision impulse, and relative velocity during collision of particles along with an admissible function determined by a method of the invention to recover force from collision impulse;

FIGS. 2A and 2B illustrate the change of contact force, collision impulse, and normal component of the relative velocity for collision of true rigid particles, for which there is an abrupt transition;

FIG. 3 is a flowchart that illustrates a preferred method of the invention for determining contact force change during collision in a multi-body system from collision impulse;

FIG. 4 illustrates a bilinear collision model;

FIG. 5 is pseudo code implementing a preferred method for the collision impulse (velocity update) 40 of the FIG. 3 method of the invention;

FIG. 6 illustrates a preferred method for constructing contact force in a uniform manner for a multiple points body collision;

FIGS. 7A-7G each show initial and final configuration of 500 particles flow simulation results, where a prior discrete element simulation is shown in FIG. 7A, and FIGS. 7B-7G show impulse derived discrete element simulation results of the invention compared to prior discrete element simulation (shown in light gray outline);

FIGS. 8A-8D are each a series of comparisons of contact force simulations for the prior discrete element simulations (black) and present impulse derived simulations (gray) for the FIGS. 7B-7G simulations;

FIG. 9 plots memory usage for the FIGS. 7A-7G simulations;

FIGS. 10A-10G each show initial and final configuration of 5000 particles flow simulation results, where a prior discrete element simulation is shown in FIG. 10A, and FIGS. 10B-10G show impulse derived discrete element simulation results of the invention compared to prior discrete element simulation (shown in light gray outline);

FIGS. 11A-11B are each a series of comparisons of contact force simulations for the prior discrete element simulations (black) and present impulse derived simulations (gray) for the FIGS. 10B-10G simulations;

FIG. 12 plots memory usage for the FIGS. 10A-10G simulations;

FIGS. 13A-13E shows initial and final configuration of 50,000 particles flow simulation results, where a prior discrete element simulation is shown in FIG. 13A, and FIGS. 13B-13E show impulse derived discrete element simulation results of the invention compared to prior discrete element simulation (shown in light gray outline);

FIGS. 14A-14B are each a series of comparisons of contact force simulations for the prior discrete element simulations (black) and present impulse derived simulations (gray) for the FIGS. 13B-13E simulations;

FIG. 15 plots memory usage for the FIGS. 13A-13E simulations;

FIGS. 16A-16B shows initial and final configuration of 500,000 particles flow simulation results compared to prior discrete element simulation (shown in light gray outline);

FIGS. 17A-17B are each a series of comparisons of contact force simulations for the prior discrete element simulations (black) and present impulse derived simulations (gray) for the FIGS. 13B-13E simulations;

FIG. 18 plots memory usage for the FIGS. 13A-13E simulations;

FIG. 19 is a flowchart that illustrates another preferred method of the invention for determining contact force change during collision in a multi-body system from collision impulse;

FIGS. 20A and 20B illustrate collision of two rigid polyhedral particles on a single contact point and the normal contact force ƒₙ as a function of deformation of the collision mass, respectively;

FIGS. 21A and 21B respectively illustrate contact force and impulse for dynamic particle collision; and

FIGS. 22A and 22B illustrate a simulation of multiple particles related to the retrieved contact force for each collision.

### DETAILED DESCRIPTION OF THE PREFERRED EMBODIMENTS

The invention provides collision impulse derived contact force determination methods, software and systems. A collision impulse derived contact force determination engine of the invention provides contact force with plausible levels of engineering accuracy, while retaining speed advantages of the collision impulse-velocity based class of engines. A collision impulse derived contact force engine of the invention can simulate a multi-body system at speeds that meet current collision impulse-velocity engines without sacrificing of the higher-order engineering detail that is characteristic of contact force-acceleration engines.

A preferred collision impulse derived contact force determination engine uses the 1st order time integration of motion, and calculates collision impulse, while directly handling the velocity. The approach allows the use of large time steps with numerical stability. Higher-order engineering details lost during the time integration are recovered via admissible functions to approximate detailed collisions. Contact force is derived with accuracy sufficient for engineering applications from the collision impulse.

A preferred embodiment method of the invention provides a modified collision impulse-velocity engine that shows a significant speed up over the contact force-acceleration based DEM engines, but also provides a physically plausible simulation with reasonable engineering accuracy. The method uses the speed-up features of the impulse-based simulation. With a collision impulse derived contact force approximation, the contact force is recovered with plausible accuracy. Advantageously, the details are by-products of the simulation and can be recovered any time when a higher level of accuracy is demanded. Also, in preferred embodiments, the contact force approximation recovery can be selectively applied to adjust simulation times based upon need for the information.

The invention has been demonstrated using polyhedral particles. Experiments compared the performance to a polyhedral DEM code. See, Zhao Nezami, Hashash, and Ghaboussi J. “Three-dimensional discrete element simulation for granular materials.” Engineering Computations. 23(7): 749-70 (2006). The experiments demonstrate preferred embodiments, and show a high level of accuracy with significant speed-up. The contact forces are also comparable to those from the corresponding DEM simulation. The invention can also be used with spherical particles. The characterization of such particles is known in the art, and represents a simpler case.

The invention has been demonstrated with propagation collision impulse. The simultaneous collision impulse engines can also provide an input that permits derivation of contact force with the present invention.

The simulations show that the advantages of the two major classes of simulation engines can be combined, that is, the invention provides both visual simulation speed and engineering accuracy. The higher-order details are reconstructed from collision impulse data with reasonable accuracy.

The simulations show that normal workstations and computers can be used for a large scale problem. Present DEM research is focused on hardware acceleration techniques such as supercomputing applications, and highly parallelizable computing devices for such problems. The invention can make the discrete element simulations more accessible to engineers and researchers. Methods of the invention permit researchers and engineers to make the most use of their machines for much more realistic simulations with a large number of particles.

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale.

Those knowledgeable in the art will appreciate that embodiments of the present invention lend themselves well to practice in the form of computer program products. Accordingly, it will be appreciated that embodiments of the present invention may comprise computer program products comprising computer executable instructions stored on a non-transitory computer readable medium that, when executed, cause a computer to undertake methods according to the present invention, or a computer configured to carry out such methods. The executable instructions may comprise computer program language instructions that have been compiled into a machine-readable format. The non-transitory computer-readable medium may comprise, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

Preferred applications of the invention include computer based design, manufacturing and engineering simulation. In such applications the invention can shorten a turnaround time to quickly evaluate new product handling and simulation-aided design. Preferred embodiments can be executed with normal desktop/workstation computing resources.

Additionally, preferred embodiments of the invention can be implemented leveraging graphics processing units (GPU) that are present in normal computers. For example, an impulse-based physics engine, Bullet Physics, has the feature for GPU processing to get more computational performance from the hardware acceleration. The additional calculations required for contact force retrieval using the admissible function can be coded for GPU on the impulse-based physics engines to be used in engineering applications. The many cores of GPUs can be leverage for parallelism.

The following table includes definitions that are used in the mathematical expressions used in the description of the preferred embodiments and the in the drawing figures.

TABLE OF SYMBOLS

| | |
|---|---|
| 1 | Identity matrix |
| f_{c(k)} | Contact force on a contact point k |
| fₙ | Normal contact force |
| f_{nc} | Retrieved normal contact force to approximate fₙ |
| fₘₐₓ | Maximum normal contact force |
| fₜ | Shear contact force |
| f_{tc} | Retrieved shear contact force |
| Gₛ | Specific gravity of solids |
| I | Moment of inertia tensor |
| kₙ | Normal contact stiffness |
| kₜ | Shear contact stiffness |
| k₁^{β} | Contact stiffness for force retrieval |
| M | Mass matrix (M = m1) |
| m | Particle mass |
| m_{col\|n} | Collision mass on a contact point to the normal contact |
| | direction |
| m_{col\|t} | Collision mass on a contact point to the tangential |
| | contact direction |
| n | Unit vector for normal collision direction |
| Rₙ | Coefficient of normal restitution |
| Rₜ | Coefficient of tangential restitution |
| R_{WB} | Coefficient of restitution by Walton and Braun |
| r | Vector pointing a point from particle's mass center |
| r^{×} | Skew-symmetric matrix notation for a vector cross product, |
| | i.e., r^{×} ≡ r× |
| t | Unit vector for tangential collision direction |
| Δt | Time step size |
| Δt_{c} | Collision period |
| ν_{Ω} | Velocity of a point in Particle Ω (ν_{Ω} = \dot{x}_{Ω} + \dot{θ}_{Ω} × r_{Ω}) |
| νᵣₑₗ | Relative velocity of contact point (νᵣₑₗ = ν_{B} − ν_{A}) |
| ν_{rel\|n} | Relative normal velocity of contact point (ν_{rel\|n} = νᵣₑₗ · n) |
| ν_{rel\|t} | Relative tangential velocity of contact point (ν_{rel\|t} = νᵣₑₗ · t) |
| \check{ᵥ}ᵣₑₗ | Approach velocity of contact point (\check{v}ᵣₑₗ = \check{v}_{B} − \check{v}_{A}) |
| \hat{ᵥ}ᵣₑₗ | Separation velocity of contact point (\hat{v}ᵣₑₗ = \hat{v}_{B} − \hat{v}_{A}) |
| Δνᵣₑₗ | Change of relative velocities of contact point (Δνᵣₑₗ = \hat{v}ᵣₑₗ − \check{v}ᵣₑₗ) |
| x | Particle position |
| α_{d} | Global damping factor |
| β_{d} | Contact damping factor |
| θ | Particle orientation |
| ι_{c(k)} | Collision impulse on a contact point k (ι_{c(k)} = ιₙ + ιₜ) |
| ιₙ | Normal collision impulse (ιₙ = ιₙn) |
| ιₜ | Tangential collision impulse (ιₜ = ιₜt) |
| ξ_{g} | Global damping ratio |
| ξ_{c} | Contact damping ratio |
| φ_{μ}′ | Inter-particle friction angle |
| μ | Friction coefficient (=tan(φ_{μ}′)) |
| ξ_{g} | Global damping ratio |
| ξ_{c} | Contact damping ratio |
| u | Translational velocity of particle |
| ω | Angular velocity of particle |
| (i) | iteration i, e.g., ν_{A}⁽ⁱ⁾: velocity of particle A |
| | at iteration i |
| (t\|i) | iteration i at a time step t, e.g., ν_{A}^{(t\|i)} |

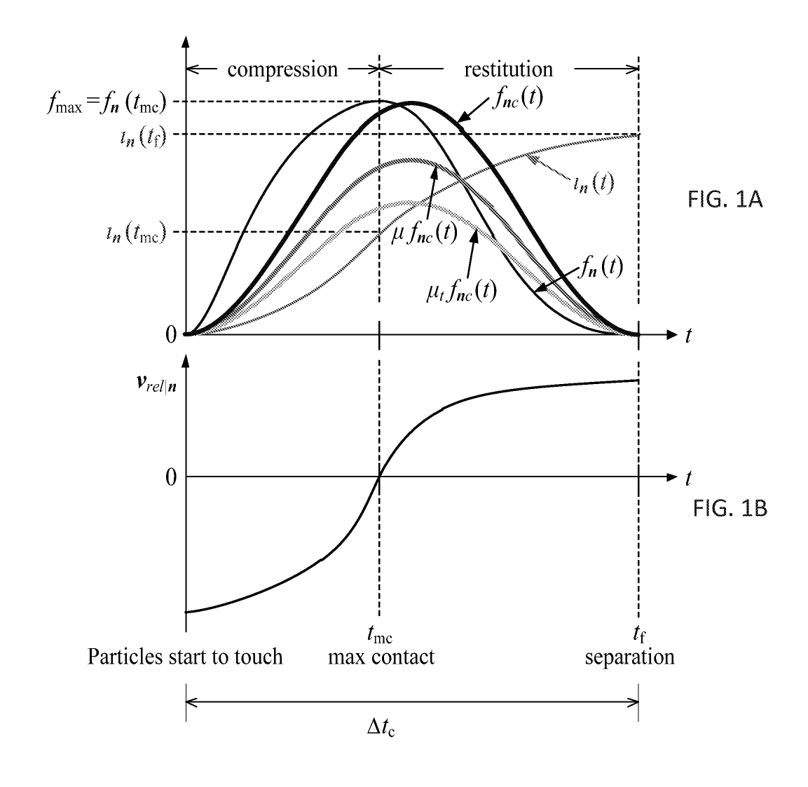

FIGS. 1A and 1B illustrate the concept of the collision impulse (but also includes an admissible function of the invention ƒ_{nc} that is used to derive contact force). Specifically, FIG. 1A shows the typical relationship between normal contact force (ƒₙ(t) and normal collision impulse (ιₙ(t)) during a single point collision period. The admissible function (ƒ_{nc}(t) for the approximation is introduced. The strain energy is stored in the bodies and the contact force increases up to the point of maximum contact during the compression period. After the compression period, the restitution period is followed, in which a part of the strain energy is transformed into kinetic energy which makes the bodies separated, and also the contact force gradually decreases until the complete separation is made. During this collision duration, the collision impulse monotonically increases, as it is the summation of the contact forces exerted to each body.

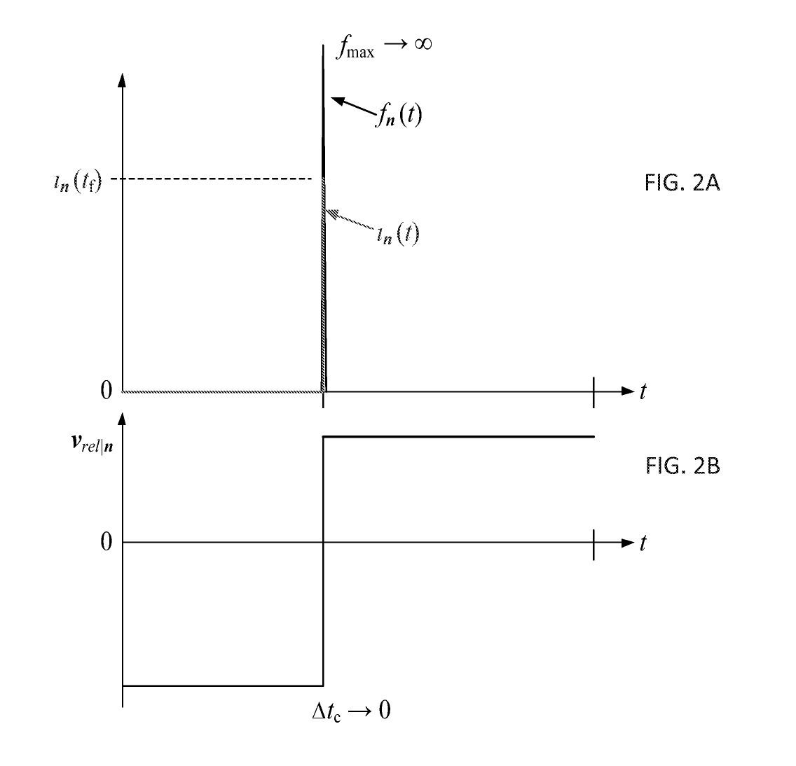

FIGS. 2A and 2B illustrate the change of contact force, collision impulse, and normal component of the relative velocity for collision of rigid particles. Stiffer collisions yield smaller collision times, increase force magnitudes, abruptly changing relatively velocities. Impulsive collision of truly rigid particles will change the velocity instantaneously and there is no smooth transition period. DEM models all the detailed collision procedure in FIGS. 1A and 1B with use of micro-time steps and delivers the contact force information at each time step. On the other hand, the impulse-based approach is targeted at such stiff collisions shown in FIGS. 2A and 2B, as it treats particles as truly rigid. Therefore, it allows using a much larger time step with no need to characterize the smooth transition.

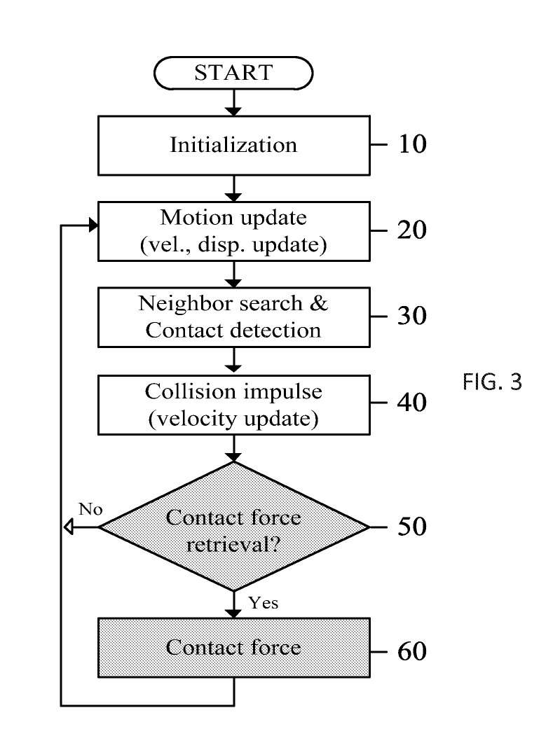

FIG. 3 illustrates a preferred embodiment method of the invention that is preferably executed in an engine of the invention. The method and engine can be implemented by software in the form of code stored on a non-transient medium and can be performed by a computer. Embodiments of the invention can simulate large scale granular material systems while running on normal workstations in a reasonable amount of run-time.

In FIG. 3, the simulation is initialized 10. Initialization includes defining initial particle positions, orientations, sizes, shapes and properties. Motion is updated in 20. A neighbor search is conducted and contact is detected 30. Collision impulse is calculated 40. A decision is made as to whether contact force should be retrieved 50. A positive decision then derives contact force from the collision impulse 60. Iteration should be finished first in 40 before 50, because the global solution should be reached (correct collision impulses for all contact pairs). In one variation, user input informs the code which contact pairs are interesting for the recovery process. If there is no such input, the code can skip 60. In the example of particle flows, user input (which can also be a pre-set parameter) informed the code the contact forces on the boundaries are only of interest, so the code conducted as such, while skipping to retrieve the contact forces between the particles.

The collision impulse is computed and applied to each contact point one by one for multiple contact points. Therefore, the iteration is necessary to resolve the collisions at every contact point in 40. This is done until the specified collision law is numerically satisfied for all contact points in a single time step.

Calculating Collision Impulse for Each Contact Point.

Consider two polyhedral particles colliding at a single contact point. Each of equation (2) and (3) represents the collision impulse calculated to each normal (ιₙ) and tangential (iₜ) direction of collision. m_{col|n} and m_{col|t} are the collision mass, and Δv_{rel|n} and Δv_{rel|t} are the change of relative velocity for a contact point to each direction. The detailed derivation for equations (2) and (3) including the collision mass in equations (4) and (5) calculation can be found in some published literatures: Mirtich, B., “Impulse-based dynamic simulation of rigid body systems,” Department of computer science. Berkeley, Calif.: University of California, (1996); Erleben, Sporring, Henriksen, and Dohlmann Physics-based animation, Hingham, Mass.: Charles River Media (2005).

$$\begin{matrix}{l}_{n} = {m}_{col \vert n} Δ {v}_{rel \vert n} = {m}_{col \vert n} Δ {v}_{rel} \cdot n = {m}_{col \vert n} ( {\hat{v}}_{rel} - {{v}^{⋁}}_{rel} ) \cdot n & ( 2 ) \\ {l}_{t} = {m}_{col \vert t} Δ {v}_{rel \vert t} = {m}_{col \vert t} Δ {v}_{rel} \cdot t = {m}_{col \vert t} ( {\hat{v}}_{rel} - {{v}^{⋁}}_{rel} ) \cdot t & ( 3 ) \\ {m}_{col \vert n} = 1 / [ {n}^{T} ( ( \frac{1}{{m}_{B}} + \frac{1}{{m}_{A}} ) 1 - {r}_{B}^{\times } {I}_{B}^{- 1} {r}_{B}^{\times } - {r}_{A}^{\times } {I}_{A}^{- 1} {r}_{A}^{\times } ) n ] & ( 4 ) \\ {m}_{col \vert t} = 1 / [ {t}^{T} ( ( \frac{1}{{m}_{B}} + \frac{1}{{m}_{A}} ) 1 - {r}_{B}^{\times } {I}_{B}^{- 1} {r}_{B}^{\times } - {r}_{A}^{\times } {I}_{A}^{- 1} {r}_{A}^{\times } ) t ] & ( 5 )\end{matrix}$$

The relative approach velocity of the contact point (\check{v}ᵣₑₗ) is known at the moment of collision. Calculation of collision impulse requires knowledge of the relative separation velocity of the contact point (\hat{v}ᵣₑₗ) to resolve the collision, as Δvᵣₑₗ=\hat{v}ᵣₑₗ−\check{v}ᵣₑₗ. Two useful concepts are employed for this: coefficient of restitution and Coulomb's friction law

Coefficient of Restitution

The coefficient of restitution quantifies the energy related characteristics of collision to the normal direction. The simplest model is provided by Newton's impact law, also known as kinematic coefficient of restitution:

$${R}_{c} = - \frac{{\hat{v}}_{rel \vert n}}{{{v}^{⋁}}_{rel \vert n}} \qquad ( 6 )$$

Newton's impact law describes the restitution with relative velocities, and it is defined as the normal component's ratio of the relative velocities before and after impact. Note the negative sign in equation (6), as the relative velocity is less than 0 when the particles are colliding. This ratio always ranges between 0 and 1. If the collision is perfectly elastic, there will be no energy loss during the collision, and R_{c} will be 1. If the collision is perfectly plastic, R_{c} will be 0 because the particles will stick to each other without any restitution phase.

For most real world collisions, there will be some energy dissipation, so R_{c} will be a fraction of 1. The value can be found via physical lab testing or calibrated via trial and error in the simulation. Once R_{c} is known, value can be plugged-in for \hat{v}_{rel|n} to compute the normal collision impulse (ιₙ) in equation (2). Newton's impact law is simple and intuitive as it is described in terms of velocity and is the most widely used in physics-based game engines.

Another coefficient of restitution known as Poisson's hypothesis or kinetic coefficient of restitution:

$${R}_{P} = \frac{{l}_{n} ( {t}_{f} ) - {l}_{n} ( {t}_{mc} )}{{l}_{n} ( {t}_{mc} )} \qquad ( 7 )$$

where ιₙ(t_{f}) is the maximum normal impulse at the end of collision and ιₙ(t_{mc}) is the normal impulse at the maximum contact (schematically shown in FIG. 1A)

In this restitution model, the collision period is explicitly divided into compression and restitution phase, the normal impulse is used to relate these phases. The definition of Rₚ also implies the shape of contact force change in FIG. 1B. If the collision is perfectly elastic, Rₚ will be 1, and ιₙ(t_{f})=2ιₙ(t_{mc}). This implies the shape of the contact force change will be symmetric. For most collisions, Rₚ will be between 0 and 1, as there will be partial energy loss during collision. In this case, ιₙ(t_{f})−ιₙ(t_{mc})<ιₙ(t_{mc}), and the shape of the change is skewed to the right.

Stronge defines the quadratic restitution law known as Stronge's hypothesis or energetic coefficient of restitution. See, Stronge, W. J., “Rigid body collisions with friction,” Proceedings: Mathematical and Physical Sciences, Vol. 431, No. 1881, pp 169-181 (1990). This law relates the work done during the compression phase and restitution phase:

$${R}_{S}^{2} = - \frac{{W}_{n} ( {t}_{f} ) - {W}_{n} ( {t}_{mc} )}{{W}_{n} ( {t}_{mc} )} \qquad ( 8 )$$

where Wₙ(t_{f}) is the final work done to the normal collision direction and Wₙ(t_{mc}) is the work done during the compression phase.

In this restitution model, the squared coefficient of restitution relates the strain energy released during the restitution phase to the energy stored during the compression phase. Like other models, this ranges between 0 and 1, i.e., 0 for a perfectly plastic and 1 for perfectly elastic. The kinematic, kinetic, and energetic coefficients of restitution are equivalent if there is no friction or the frictional slip is constant during the collision. This work argues that the energetic coefficient of restitution is the most accurate.

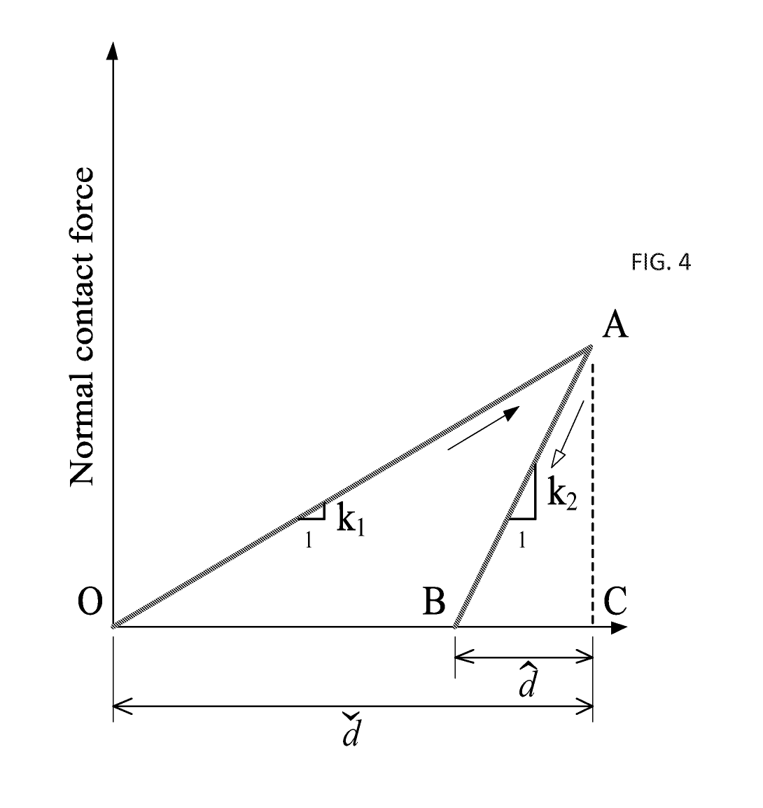

Walton and Braun proposed another quadratic coefficient of restitution, which is a version of the energetic coefficient of restitution by Stronge based on a bilinear model for the collision. This normal contact force model exhibits the penetration dependent bilinear hysteresis shown in FIG. 4, whereby the normal contact stiffness during the compression phase is k₁, which is different from the normal contact stiffness, k₂, during the restitution phase. See, Walton & Braun, “Viscosity, Granular-Temperature and Stress Calculations for Shearing Assemblies of Inelastic, Frictional Disks,” Journal of Rheology, Vol. 30, No. 5, pp 949-980 (1986). In this restitution model, the squared coefficient of restitution is simply the ratio between the two stiffnesses as shown in equation (9). This is derived from the ratio of energy stored and released based on the bilinear curves, i.e., ABC/AOC in the figure. See, Vu-Quoc, Loc & Xiang Zhang “An Elastoplastic Contact Force-displacement Model in the Normal Direction: Displacement-driven Version,” Proc. R. Soc. Lond. A, Vol. 455, pp 4013-4044 (1999). Preferred embodiments of the invention use this Walton-Braun restitution model and other models discussed above to derive contact force from the collision impulse.

$${R}_{WB}^{2} = \frac{ABC}{AOC} = \frac{{k}_{1}}{{k}_{2}} \qquad ( 9 )$$

Coulomb's Friction Law

Coulomb's friction law describes the relationship between the friction force and the normal contact force. Therefore, once the magnitude of the normal contact force is known, the friction force can be applied to the direction which is the opposite of the sliding at contact point. This implies the iteration loop in the code should go over the normal component of the collision first to quantify the magnitude. Originally, Coulomb has described the law in terms of force, but the integral of the force can be used in the impulse-based simulation. Specifically,

Δv_{rel|t}≠0→ιₜ=−μ∥ιₙ∥t (10)

Δv_{rel|t}=0→∥ιₜ∥≦μ∥ιₙ∥ (11)

Collision Resolution

Once collision impulse is known, the particle velocities can be updated such that they can be separated:

$$\begin{matrix}- {l}_{A}^{( i )} = {l}_{B}^{( i )} = {l}^{( i )} & ( 12 ) \\ Δ {u}_{Ω}^{( i )} = \frac{{l}^{( i )}}{{m}_{Ω}} & ( 13 ) \\ Δ {ω}_{Ω}^{( i )} = {I}_{Ω}^{- 1} ( {r}_{Ω} \times {l}^{( i )} ) & ( 14 ) \\ {u}_{Ω}^{( i + 1 )} = {u}_{Ω}^{( i )} + Δ {u}_{Ω}^{( i )} & ( 15 ) \\ {ω}_{Ω}^{( i + 1 )} = {ω}_{Ω}^{( i )} + Δ {ω}_{Ω}^{( i )} & ( 16 )\end{matrix}$$

where Ω is A, B and Δu_{Ω}⁽ⁱ⁾, Δω_{Ω}⁽ⁱ⁾ are the change of translational and angular velocity of particle Ω at iteration i.

It should be noted only the velocities of each particles are updated and there is no position update. The positions of the particles will be updated in step 20 of FIG. 3.

Multiple Points Collision

Simulation of granular materials requires resolving multiple contact points between two particles and also a group of particles in collision together. In the impulse-based simulation, these multiple contact points are resolved via iterations. The collision mass needs to be calculated only once a time step; it is purely determined by contact geometry and particle mass as shown in equation (4) and (5). Determination of the collision mass for each contact point is determined at the beginning of Step 40 of FIG. 3. Pseudo-code for the iterative scheme is provided in FIG. 5, presenting three routines: preprocessing (C), multiple_collisions_resolution (C) and pairwise_collision_resolution (C). Once Step 40 starts, preprocessing (C) is called for preprocessing jobs, including the collision mass calculation. multiple_collisions_resolution (C) is then called to resolve the single point collisions one by one with pairwise_collision_resolution (C). This iteration is repeated until the iteration reaches the maximum number of iterations set by the user, or the specified collision law is numerically satisfied for all contact points. A preferred stopping criterion requires that the normal separation velocity over the contact points is within the numerical tolerance (ε) of the target separation velocity to the normal collision direction:

∥ĉ_{rel|n}⁽ⁱ⁾−\hat{v}_{rel|n}∥<ε (17)

where \hat{v}_{rel|n}⁽ⁱ⁾ is the separation velocity updated at an iteration i and \hat{v}_{rel|n} is the theoretical target can be obtained from Newton's impact law in equation (6).

The collision impulse calculated is accumulated at each contact point over the iterations. The accumulated impulse converges to a global solution until the iteration terminates. See, Catto, Erin, “Fast and Simple Physics using Sequential Impulses,” Game Developers Conference 2006 San Jose, Calif.

Motion Update

The velocities from the collisions are updated Step 40, while, in Step 20, the positions and orientations of particles are updated and also the external forces are integrated to update the velocity for the next time step. If * is defined as the last number of iteration in Step 40, at the beginning of the Step 20, the particles have the velocity, u_{Ω}^{(t|t=*)} and ω_{Ω}^{(t|i=*)}. The positions are then updated as follows, equation (18) for translation and (19) for rotation:

x_{Ω}^{(t+1)}=x_{Ω}^{(t)}+u_{Ω}^{(t|i=*)}Δt (18)

θ_{Ω}^{(t+1)}=θ_{Ω}^{(t)}+ω_{Ω}^{(t|i=*)}Δt (19)

The external forces are integrated via Newton-Euler equations and the new velocity for the next time step can be calculated as shown below:

u_{Ω}^{(t+1|i=0)}=u_{Ω}^{(t|i=*)}+m_{Ω}⁻¹ƒ_{Ω}^{(t+1)}Δt (20)

ω_{Ω}^{(t+1|i=0)}=ω_{Ω}^{(t|i=*)}+I_{Ω}⁻¹τ_{Ω}^{(t+1)}Δt (21)

where ƒ_{Ω}^{(t+1)} is the applied force on particle Ω at time step t+1 and τ_{Ω}^{(t+1)} is the torque.

Warm Starting for Persistent Contact

Warm starting is an optional numerical technique used in impulse-based simulations, aiming at a faster convergence to the global solution. The concept is to re-use the old collision impulse (from the previous time step) on persistent contact points at the beginning of the next time step, to start with an initial guess already close to the solution. Therefore, for the contact points having similar impulse to that of the previous time step, it helps the local collision solver can obtain the global solution with fewer numbers of iterations. For example, a box resting on ground will have the same normal impulse value over the time steps. In this case, if warm starting is used to apply the cached impulse for the contact points, then iterations can be significantly reduced. Warm starting can be optionally used right after preprocessing (C), once the collision mass is calculated.

Position Correction

The impulse-based simulation does not have an explicit non-penetration constraint between particles, so recovery from incorrect penetration errors is prevented. A position correction technique can be used by applying arbitrary normal impulse to resolve the overlap. Consider two particles showing penetration with depth d. In this case, an additional relative velocity can be estimated to correct the penetration to the normal collision direction:

$${\tilde{v}}_{rel \vert n} = \frac{d}{Δ t} \qquad ( 22 )$$

This value can be added to the target separation velocity (\hat{v}_{rel|n}) in equation (17) so that additional normal impulse can be employed to resolve the particle pair in collision. Consideration of a full \tilde{v}_{rel|n} means the overlap will be resolved in a single time step. However, this generally yields an explosive simulation by adding too much energy, so a fraction of \tilde{v}_{rel|n} is empirically considered to have a gentle resolution on the overlap and is preferably applied to resolve the explosive simulation issue.

Derivation of Contact from Impulse Step 60 with an Admissible Function

An admissible function is introduced to permit a reasonable approximation of the change of the contact force during the collision period.

The typical relationship between normal contact force (ƒₙ(t)) and normal collision impulse (ιₙ(t) during a single point collision period is shown in FIG. 1A with an admissible function (ƒ_{nc}(t)) for the approximation. The admissible function is introduced to mimic the typical changes of the contact force during the collision period. Because the contact force changes smoothly, a sinusoidal function which apparently resembles the smooth changes can be adopted. In preferred embodiments, the smooth function is a sinusoidal function. The shape of contact force change is skewed to the right for most collision cases, as implied by Poisson's hypothesis. Therefore, the time point at which the maximum contact reaches might not be accurate, as a sinusoidal function is symmetric. However, the collision period is generally very short as a fraction of a micro second, and is not an issue in a large scale granular materials simulation.

Various sinusoidal functions can be considered for the admissible function. A preferred embodiment utilizes a sine-squared function as shown in equation (23).

$${f}_{nc} ( t ) = {f}_{max} {sin}^{2} ( \frac{π t}{Δ {t}_{c}} ) \text{:} 0 \leq t \leq Δ {t}_{c} \qquad ( 23 )$$

This preferred admissible function is advantageous because the use of a sine-squared function makes the relation between ιₙ and ƒₘₐₓ (or Δt_{c}) beautifully simple as shown in equation (24). Therefore, once either collision duration (Δt_{c}) or magnitude (ƒₘₐₓ) is known, constructing the final ƒ_{nc}(t) is straightforward, as ιₙ is already known from Step 40 (FIG. 3).

$$\begin{matrix}{l}_{n} = {\int }_{0}^{Δ {t}_{c}} {f}_{nc} ( t ) d t \\ = {f}_{max} {\int }_{0}^{Δ {t}_{c}} {sin}^{2} ( \frac{π t}{Δ {t}_{c}} ) d t \\ = {f}_{max} \frac{Δ {t}_{c}}{2} \\ = {f}_{avg} Δ {t}_{c}\end{matrix} \qquad ( 24 )$$

Second, the function shape resembles the real force change more than the other types of sinusoidal functions, e.g., sin(πt/Δt_{c}) without square. Due to the gentle contact force change at a small deformation, the contact force change over the collision period generally shows a tail, i.e., curvature change, at the beginning and the end of a collision. The sine-squared function models such a tail, therefore, provides a more reasonable approximation to the contact force.

Determination of the Collision Period and the Magnitude of the Normal Contact Force.

The mathematical equations to determine the collision duration (Δtₐ) and the magnitude (ƒₘₐₓ) of the normal contact force is derived based on the work-energy theorem to the normal direction of collision. When particles are colliding, the kinetic energy is transferred to the strain energy, and only a part of the kinetic energy is restored from the strain energy due to the energy loss for most collisions. With this in mind, the change of the kinetic energy can be calculated as follows:

$$Δ KE = \frac{1}{2} {m}_{col \vert n} {\hat{v}}_{rel \vert n}^{2} - \frac{1}{2} {m}_{col \vert n} {{v}^{⋁}}_{rel \vert n}^{2} \qquad ( 25 )$$

This is the net work done by the contact force applied during the collision period. Equation (26) shows equation (25) in which Newton's impact law (equation (6)) is plugged in.

$$\begin{matrix}Δ KE = \frac{1}{2} {m}_{col \vert n} {R}_{c}^{2} {{v}^{⋁}}_{rel \vert n}^{2} - \frac{1}{2} {m}_{col \vert n} {{v}^{⋁}}_{rel \vert n}^{2} \\ = \frac{1}{2} {m}_{col \vert n} {{v}^{⋁}}_{rel \vert n}^{2} ( {R}_{c}^{2} - 1 )\end{matrix} \qquad ( 26 )$$

The change of strain energy during the collision can be formulated in a similar way. The bilinear elasto-plastic contact model of Walton and Braun (1986) in FIG. 4 is used.

$$Δ SE = \frac{1}{2} {k}_{1} {{d}^{⋁}}^{2} - \frac{1}{2} {k}_{2} {\hat{d}}^{2} \qquad ( 27 )$$

where \check{d} is the penetration at the maximum contact, and \hat{d} is the restored penetration during the restitution phase as shown in FIG. 4.

As only the normal component of collision is considered, the principle of the conservation of mechanical energy can be used to equate (25) with (27):

ΔKE=−ΔSE (28)

Equation (27) is described as contact stiffness and penetration. The

Walton-Braun restitution law (in equation (9)) can be utilized to reformulate equation (27) in terms of the restitution. For a linear spring, the contact stiffness is related to the penetration as a reciprocal to a given contact force. Therefore, a similar equation to equation (9) can be derived as shown in equation (29). Equation (30) shows the final equation after substitution of equation (9) and (29) into equation (27).

$$\begin{matrix}{R}_{WB}^{2} = \frac{\hat{d}}{{d}^{⋁}} & ( 29 ) \\ - Δ SE = \frac{1}{2} \frac{{k}_{1}}{{R}_{WB}^{2}} {{d}^{⋁}}^{2} {R}_{WB}^{4} - \frac{1}{2} {k}_{1} {{d}^{⋁}}^{2} = \frac{1}{2} {k}_{1} {{d}^{⋁}}^{2} ( {R}_{WB}^{2} - 1 ) & ( 30 )\end{matrix}$$

Walton-Braun restitution model R_{WB} is a version of R_{S} based on the bilinear collision model as discussed before. Stronge (1990) showed R_{c}, R_{P} and R_{S} are equivalent unless the frictional slip stops or changes the direction during the collision. This formulation is targeted at hard bodies' collision take place for an infinitesimal collision period. Therefore, the restitution models are considered equivalent in this formulation, assuming the slip is constant, if there is, during the collision period. A goal of this preferred embodiment of the invention is not a microscopic analysis on a pairwise collision, but the fast large scale simulation of discrete bodies with reasonable accuracy. Therefore, any error from this assumption is expected to be small from the macroscopic point of view.

Approaching the Problem from the Macroscopic View

Substituting equation (26) and (30) with assumption of R_{WB}=R_{c}, the penetration in terms of the approach velocity is shown in equation (33):

$$\begin{matrix}\frac{1}{2} {m}_{col \vert n} {{v}^{⋁}}_{rel \vert n}^{2} ( {R}_{c}^{2} - 1 ) = \frac{1}{2} {k}_{1} {{d}^{⋁}}^{2} ( {R}_{WB}^{2} - 1 ) & ( 31 ) \\ {m}_{col \vert n} {{v}^{⋁}}_{rel \vert n}^{2} = {k}_{1} {{d}^{⋁}}^{2} & ( 32 ) \\ {d}^{⋁} = - \sqrt{\frac{{m}_{col \vert n}}{{k}_{1}}} {{v}^{⋁}}_{rel \vert n} & ( 33 )\end{matrix}$$

where \check{v}_{rel|n} is the approach velocity between particles, which is defined as negative. Equation (33) is then used to get the formulation for ƒₘₐₓ as shown below:

$${f}_{max} = {k}_{1} {d}^{⋁} = {k}_{1} ( - \sqrt{\frac{{m}_{col \vert n}}{{k}_{1}}} {{v}^{⋁}}_{rel \vert n} ) = - \sqrt{{k}_{1} {m}_{col \vert n}} {{v}^{⋁}}_{rel \vert n} \qquad ( 34 )$$

As shown in equation (34), ƒₘₐₓ can be found with k₁, m_{col|n} and \check{v}_{rel|n}. The collision mass (m_{col|n}) and the approach velocity (\check{v}_{rel|n}) are already known during the impulse-based simulation, and the normal contact stiffness (k₁) needs to be selected and calibrated as done in the conventional DEM. Now that ƒₘₐₓ is known, it is straightforward to get the collision duration (Δt_{c}) using the equation (24), in which the normal collision impulse (ιₙ) is also known during the impulse-based simulation:

$$Δ {t}_{c} = 2 \frac{{l}_{n}}{{f}_{max}} \qquad ( 35 )$$

Determination of Shear Contact Force.

The tangential component (ιₜ) is also known along with the normal component (ιₙ) of impulse after each time step of impulse-based simulation ends (Steps 20-40). Applying Coulomb's friction law, the shear contact force is bound by the normal contact force.

|ƒₛ∥≦μ∥ƒₙ∥ (36)

For this reason, the shear contact force change will be approximated to have a similar shape with the normal contact force function (ƒ_{nc}(t)) constructed above.

$${μ}_{t} = \frac{‖ {l}_{t} ‖}{‖ {l}_{n} ‖} \text{:} 0 \leq {μ}_{t} \leq μ \qquad ( 37 )$$

If there is slip between particles, μₜ will be the same with μ, otherwise, smaller than μ. FIG. 1A schematically shows that shear contact force can be constructed, bound by the normal contact force constructed.

Contact Force from Static Contact

In case of static contacts, e.g., a particle resting on the ground, no special technique is necessary to retrieve the contact force because the contact force will not change during the contact time (Δt_{c}). Also, the contact period will be the same with the time step considered, i.e., Δt_{c}=Δt. Therefore, once we have the impulse is obtained from the impulse-based simulation, dividing by the time step yields a constant force. Specifically,

$$f = \frac{l}{Δ t} \qquad ( 38 )$$

To determine if particles are colliding or in a static contact, a criterion can be checked before the contact force is retrieved. In a preferred embodiment, if either of the following criteria is met, the particle pair is considered colliding:)

−v_{rel|n}^{(t|i=0)}>gΔt or |v_{rel|n}^{(t|i=*)}|>ε subject to ιₙ>0 (39)

where v_{rel|n}^{(t|i=0)} is the relative normal velocity at the beginning of the time step t with iteration i=0. This is the relative velocity between two particles after integrating the external force (equation (20), (21)). Similarly, v_{rel|n}^{(t|i=*)} is the relative normal velocity at the end of the time step t with iteration i=*, whereby * is the last number of iteration in Step 40. The gravitational acceleration is shown as g in equation (39) and ε is a tolerance value. If the number of contact points is more than one, e.g., polyhedral contact, an average velocity for all contact points can be used in equation (39).

The first criterion in equation (39) is to detect the collision at the beginning of the time step, while the second criterion is to check the dynamic state at the end of the time step. The criteria are only checked if the normal collision impulse (ιₙ) is positive.

At the beginning of each time step, the particle velocity is updated due to the gravity. Therefore, gΔt is the tolerance to check if the particles are colliding or in a resting contact. Even though the particles were in a static contact mode at the beginning, it is possible for them to separate or even collide due to the neighboring particles touching them. As the local collision solver iteratively goes through all the particle pairs to find the global solution in the system, the propagated collision impulse from one part may trigger the collision to the sleeping particles. The second criterion is for checking the state change.

Contact Force on Multiple Collision Points

With the invention, an engine can construct the contact force on the multiple points collision. After each time step of impulse-based simulation ends, collision impulse information for each contact point is available, so the contact force for each can be derived. Unknown is the information on when the particles' collision have been exactly made during the given time step. In DEM, the detailed contact process is tracked down with a micro time step, but impulse-based simulation is generally performed with a much larger time step, no information on the exact time of the collisions made in the middle of the large time step.

A preferred method of the invention constructs them in a uniform manner because the collisions are not likely to be concentrated on a certain period during the given time step. This assumption is particularly applicable and appropriate for a large scale granular materials simulation.

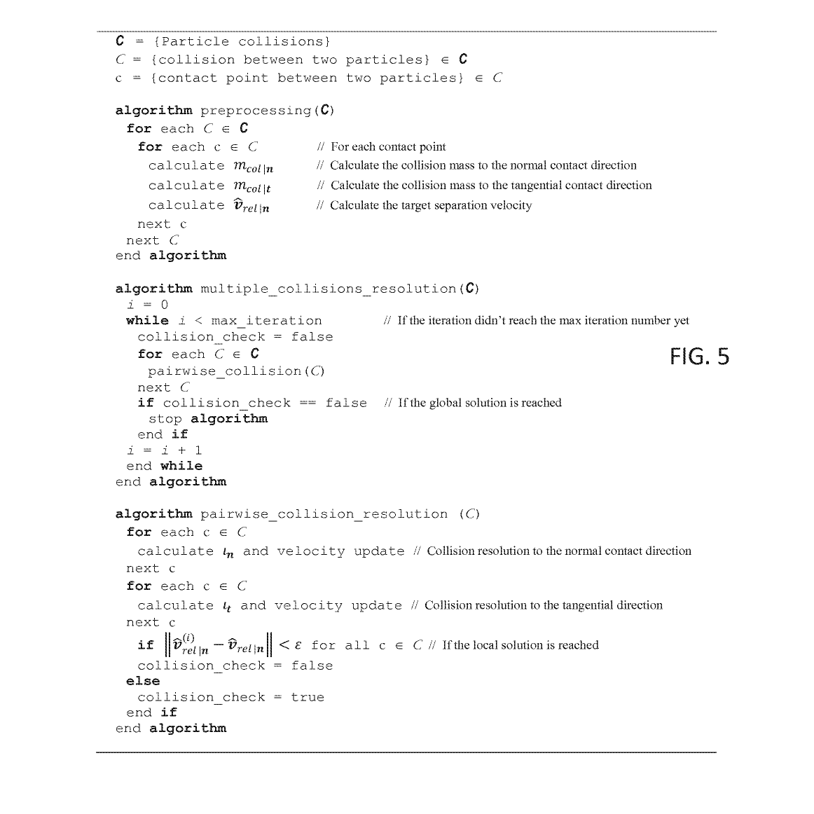

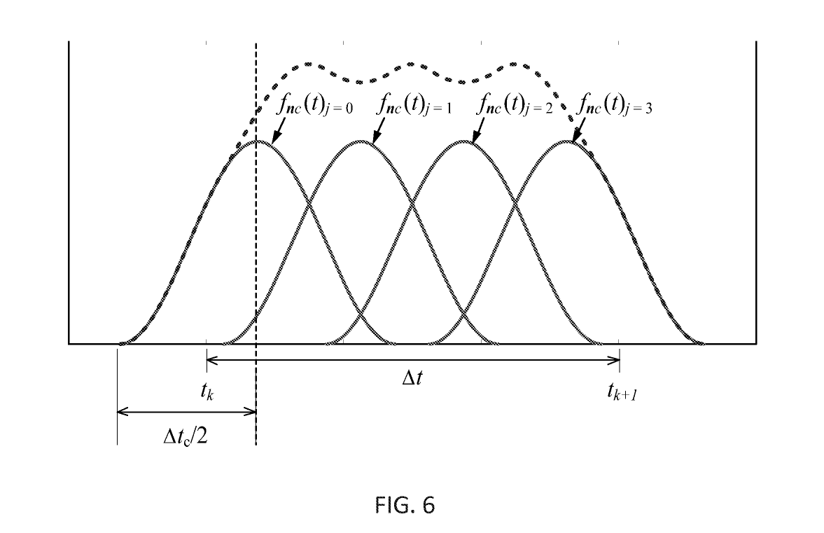

FIG. 6 illustrates this procedure of contact force construction on multiple points collision. It is first necessary to construct the contact force functions for each collision impulse. In FIG. 6, four individual normal contact force functions from the each of four collision impulses are shown. Once constructed, they are then placed uniformly over the time step. The following equation provides a uniform placement:

$$t = {t}_{k} + Δ t ( \frac{2 j + 1}{2 N} ) - \frac{Δ {t}_{c}}{2} \qquad ( 40 )$$

where tₖ is the simulation time whereby the corresponding time step starts. N is the total number of contact force functions (4 in the example of FIG. 6) and jε{0, 1, 2 . . . , N−1}.

Summations can be made for the area in which the functions overlap after being evenly placed over the time step. The finally determined contact force function is illustrated as a dotted line in FIG. 6. Any static contact force can be simply added up without building a sinusoidal contact force function, as they are constant throughout the time step.

Simulation Results

Simulations were conducted to test performance of the invention which has been named as impulse-based Discrete Element Method (iDEM), and compared to traditional DEM. The results show that the invention can substantially reduce CPU time to simulate large scale granular materials without sacrificing accuracy necessary for engineering applications. The methods of the invention show phenomenal speed-up with reasonable levels of accuracy. The levels of accuracy are suitable for a general granular materials simulation.

2D particle flows were simulated to validate and verify the code by varying the number of particles, time steps. Double- and single-precision floating-point arithmetic were also tested on each 32- and 64-bit machine. Accuracy is checked in terms of configuration geometry and contact force retrieved. The code speed-up and the memory usage were also quantitatively compared with the corresponding DEM simulations. The particles flow simulations were conducted in the following procedure: a certain number of particles were poured into a container first. After a certain simulation time passes, one of the vertical walls is removed to make the particle flow. The number of particles tested is 500, 5000, 50000 and 0.5 million and the particle size has been selected such that the height of the poured samples is theoretically same.

Table 1 summarizes the types of simulations.

TABLE 1
Types of particle flows simulation conducted

| | Δt_{iDEM}/ | #of particles | | | |
|---|---|---|---|---|---|
| | Δt_{DEM} | 500 | 5,000 | 50,000 | 500,000 |
| DEM | 1 | ** | ** | x | x |
| iDEM | 1 | ** | ** | x | x |
| | 10 | ** | ** | x | x |
| | 50 | ** | ** | x | x |
| | 100 | **, * | **, * | **, *, ††, † | x |
| | 200 | x | x | x | † |
| | 500 | ** | ** | ** | † |

| | | | | |
|---|---|---|---|---|
| Particle | 20 | 6.32 | 2 | 0.632 |
| size (mm) | | | | |
| Δt_{DEM} | 2.83 × | 5.03 × | 8.94 × | 1.59 × |
| (sec) | 10⁻⁵ | 10⁻⁶ | 10⁻⁷ | 10⁻⁷ |

x: no simulation conducted
On 32-bit machine:
** double-precision simulation
* single-precision simulation
On 64-bit machine:
††: double-precision simulation
†: single-precision simulation

Table 2 shows the DEM and present invention (iDEM) parameters and values.

TABLE 2
DEM and iDEM parameters and values used for the simulations

| | | | |
|---|---|---|---|
| Common | φ′_{μ} | (deg.) | 27 |
| parameters | Gₛ | (—) | 2.6 |
| DEM | contact damping | (%) | 10 |
| | kₙ | (kN/m) | 260 |
| | kₛ | (kN/m) | 204 |
| iDEM | R_{c} | (—) | 0.73 |
| | k₁ | (kN/m) | 260 |

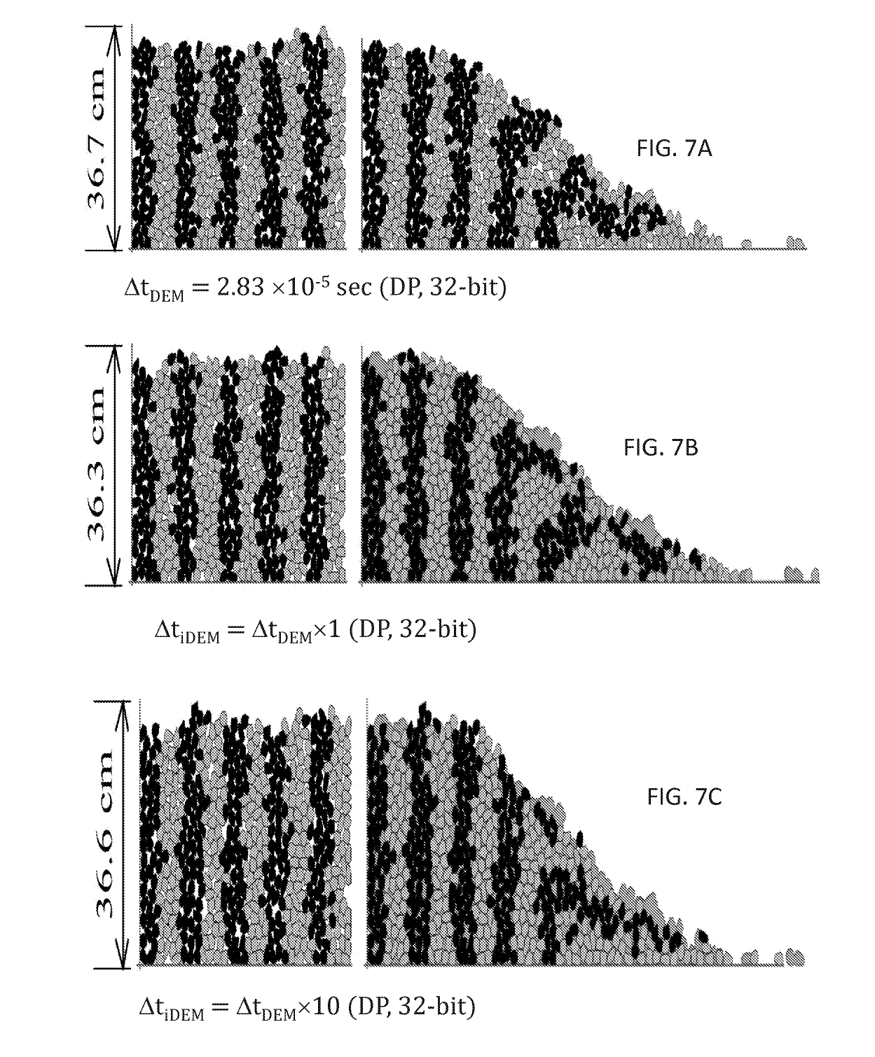

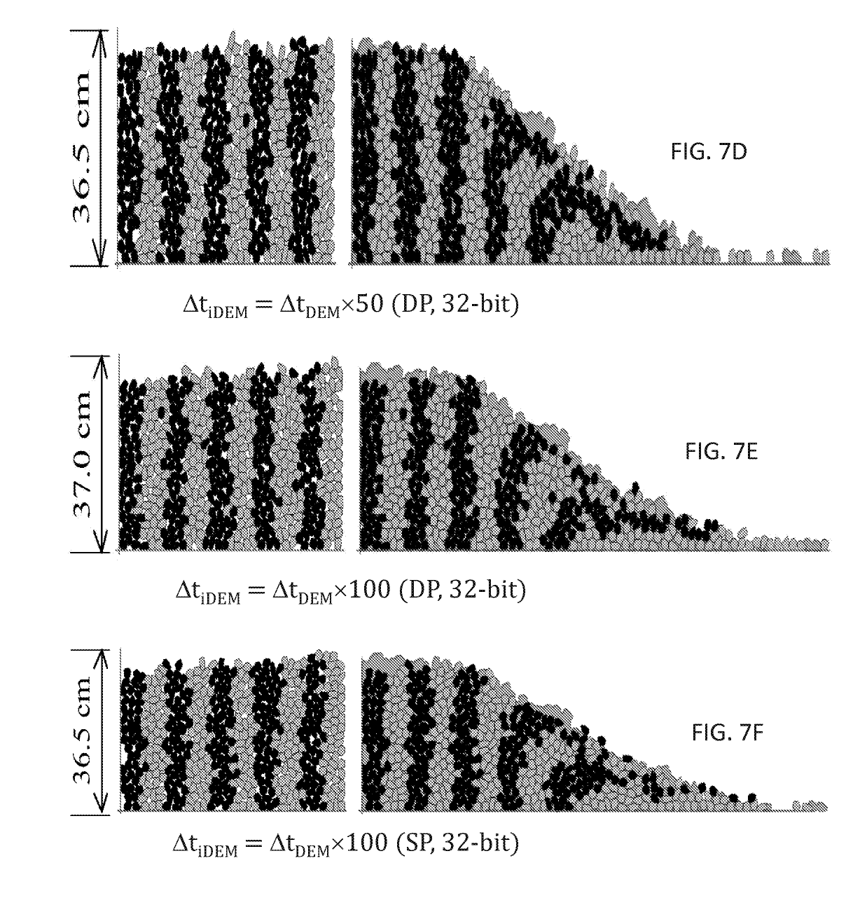

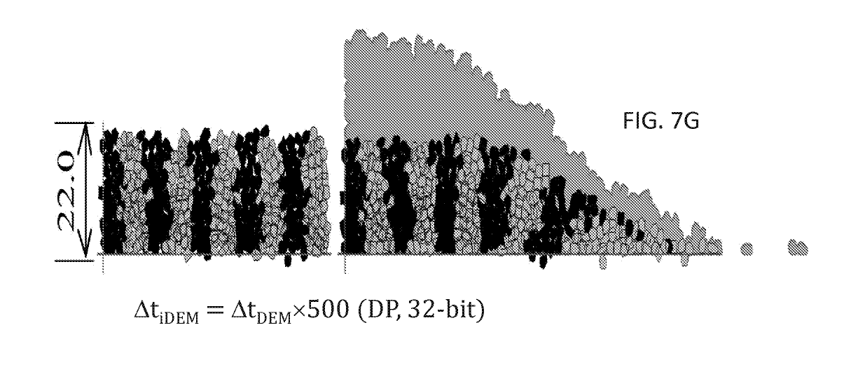

The particles flow simulations are first conducted with 500 particles. For iDEM, different time steps are used from Δt_{iDEM}=Δt_{DEM}×1 to ×500. The DEM time step (Δt_{DEM}) is calculated based on the contact stiffness carefully calibrated in Lee et al. (Lee, Hashash, and Nezami “Simulation of triaxial compression tests with polyhedral discrete elements,” Computers and Geotechnics, Vol. 43, pp 92-100 (2012)) used the same code, BLOKS3D. FIG. 7A shows initial and final configuration of 500 particles flow, where the DEM simulation is shown in FIG. 7A, and other figures from FIGS. 7B-7G show iDEM simulation results. The final configuration from DEM simulation is also shown as a background silhouette for comparison with iDEM configurations. They are comparable up to Δt_{iDEM}=Δt_{DEM}×100. The iDEM configuration at Δt_{iDEM}=Δt_{DEM}×500 shows large overlaps between particles, which requires additional numerical recipes to correct this configuration error. FIG. 7G reveals the error. This iDEM simulation result with Δt_{DEM}×500 (the largest time step size in the study), so there are penetration errors between the particles, and geometric fidelity is lost in the configuration. This implies the time step size is limited by the physics of the problem whereby too large of a time step size will result in particles passing through each other, but not limited by numerical stability and very small time step size unlike the conventional DEM.

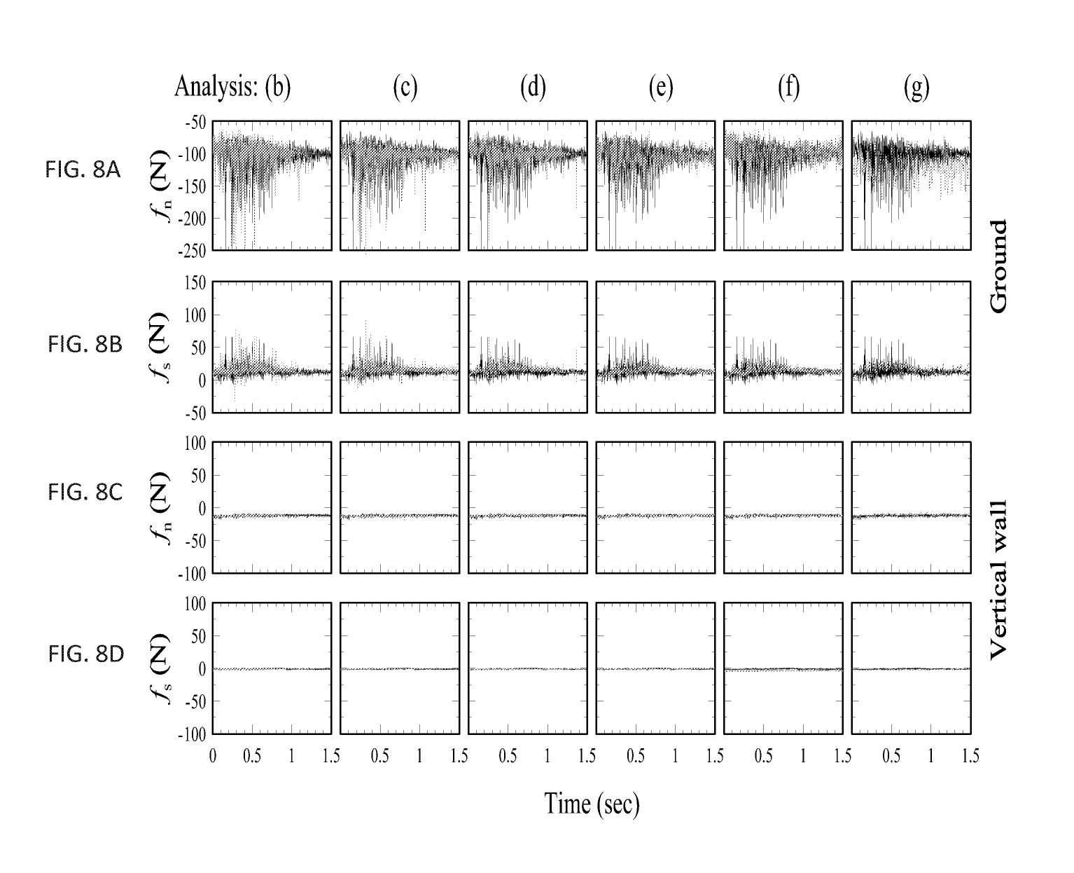

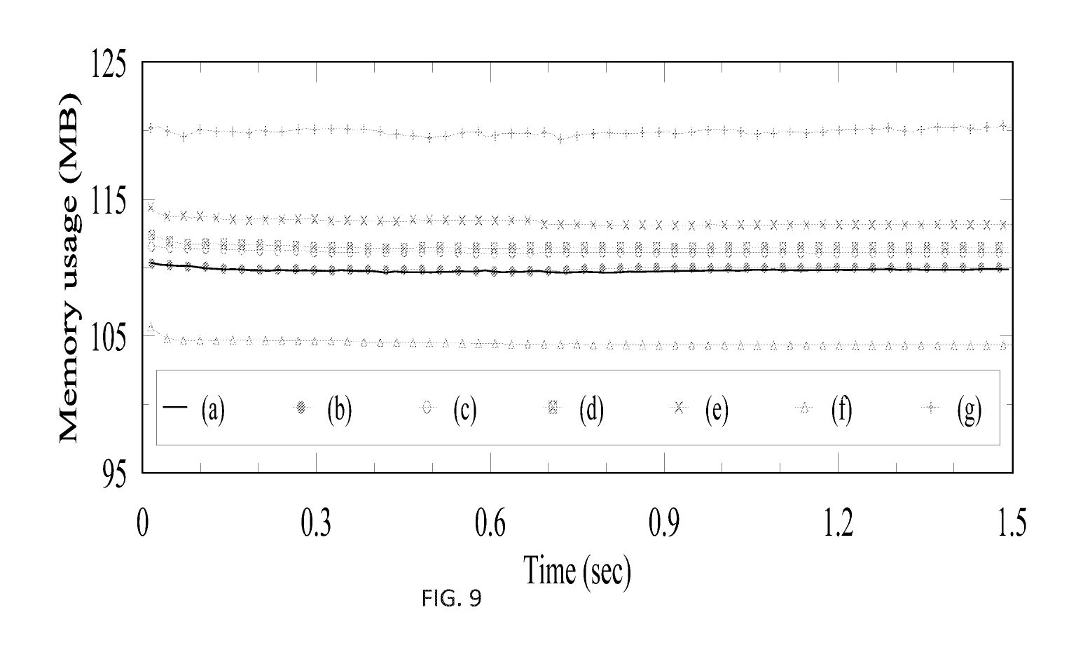

Contact forces recovered from the collision impulses are shown in FIG. 8.

They are retrieved from the collision impulses on the ground and the vertical walls. As shown in the figures, all of them show very good agreement with the DEM simulation result even for Δt_{iDEM}=Δt_{DEM}×500. FIG. 9 shows the memory usage measured during the flows simulation. Private Bytes has been recorded for the memory usage, as it is the size of memory the simulation code asks for. With use of a larger time step, there is tendency the memory usage slightly increases. This is because a longer contact list is made with use of a larger time step. As shown in FIG. 7, the iDEM configuration at Δt_{iDEM}=Δt_{DEM}×500 shows large overlaps, so the increased usage of memory partly comes from the configuration error. However, for the other iDEM simulations, configurations look very comparable to DEM, so the memory increase solely comes from the longer list of contact pairs has to be handled in a single time step.

FIG. 7 to FIG. 9 also compare the results from iDEM simulation at Δt_{iDEM}=Δt_{DEM}×100 with double- and single-precision floating point format on a 32-bit machine. The purpose of these simulations was to test to see if memory savings and code speed-up could be achieved together while keeping the simulation accuracy with the single precision arithmetic. A good accuracy is shown in terms of both configuration and contact force retrieved. Memory usage has been indeed decreased, which is even lower than DEM as shown in FIG. 9.

The CPU time measured and code speed-up is compared in Table 3.

TABLE 3
CPU time comparison for 500 particles flow

| | | | | CPU | |
|---|---|---|---|---|---|
| | | | CPU archi- | time | |
| | Δt (sec) | Precision | tecture | (sec) | Speed-up |
| DEM | 2.83 × 10⁻⁵ | Double | 32-bit | 373 | 1 |
| iDEM | Δt_{DEM} × 1 | Double | 32-bit | 398 | 0.94 |
| | Δt_{DEM} × 10 | Double | 32-bit | 43 | 8.7 |
| | Δt_{DEM} × 50 | Double | 32-bit | 9 | 41.4 |
| | Δt_{DEM} × 100 | Double | 32-bit | 5.1 | 73.1 |
| | Δt_{DEM} × 100 | Single | 32-bit | 4.7 | 79.4 |
| | Δt_{DEM} × 500 | Double | 32-bit | 1.4 | 266.4 |

Significant speed up is shown in iDEM with use of larger time steps. iDEM simulation at Δt_{iDEM}=Δt_{DEM}×500 is real-time, as the measured CPU time is close to the simulation duration which is 1.5 sec. Although the configuration is less comparable, it could be very useful for a quick estimation of the contact force, as it shows a good accuracy.

The particles flow simulations with 5,000 particles are then conducted, as similarly done for 500 particles. The particle size has been selected such that the height of the poured particles into the container could be the same with 500 particles simulation.

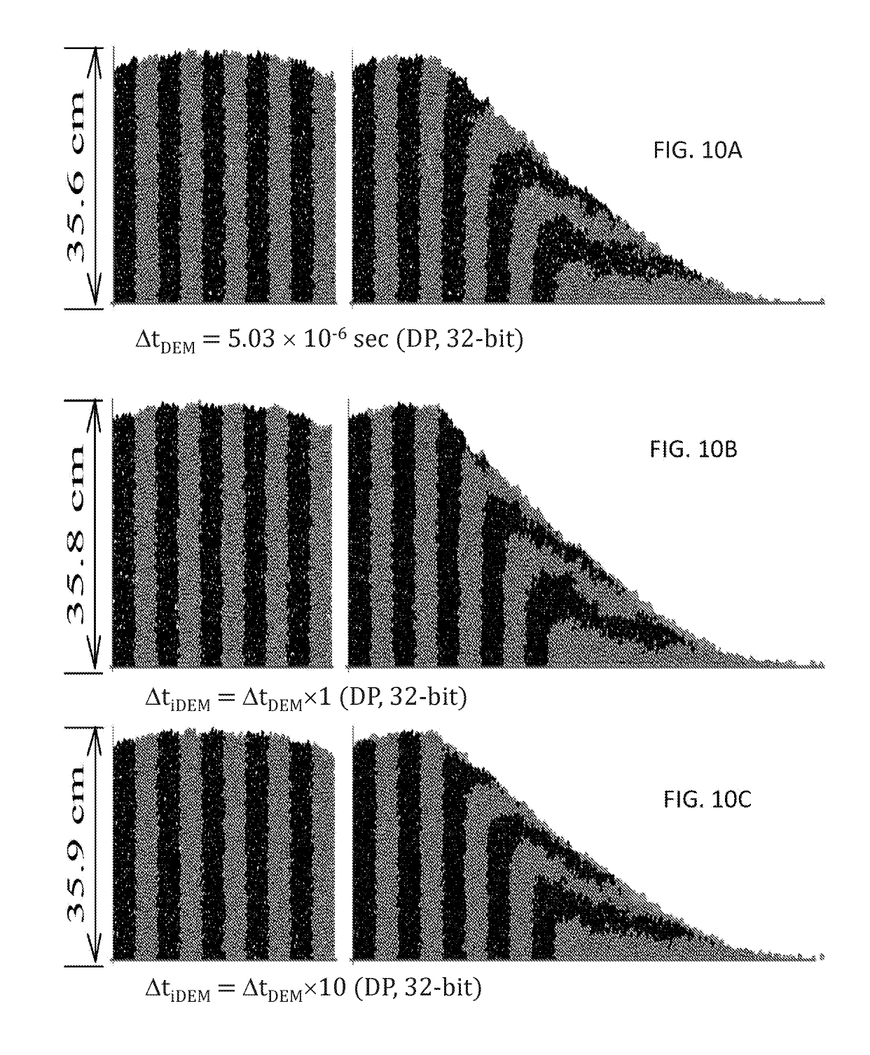

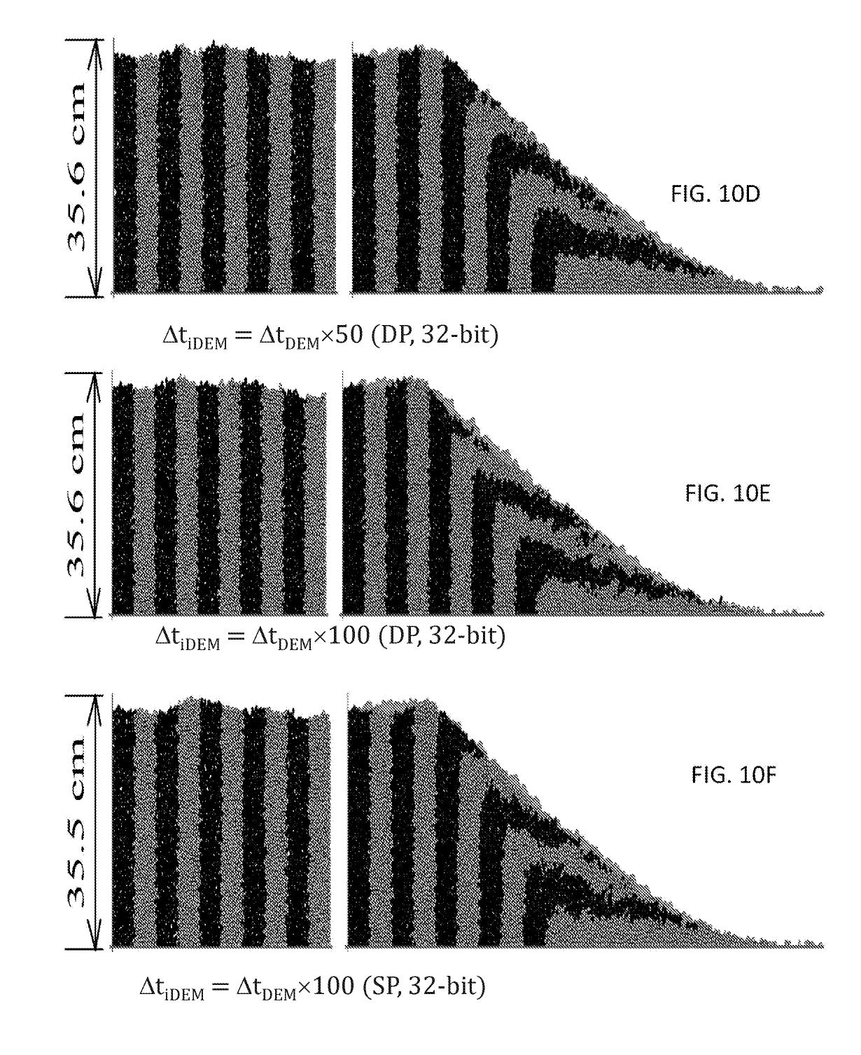

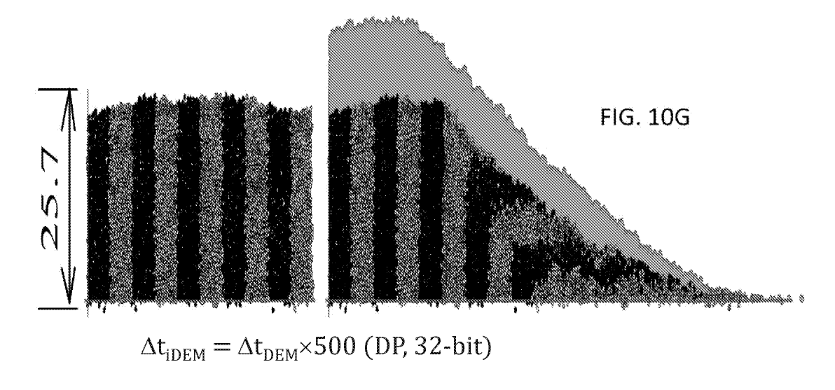

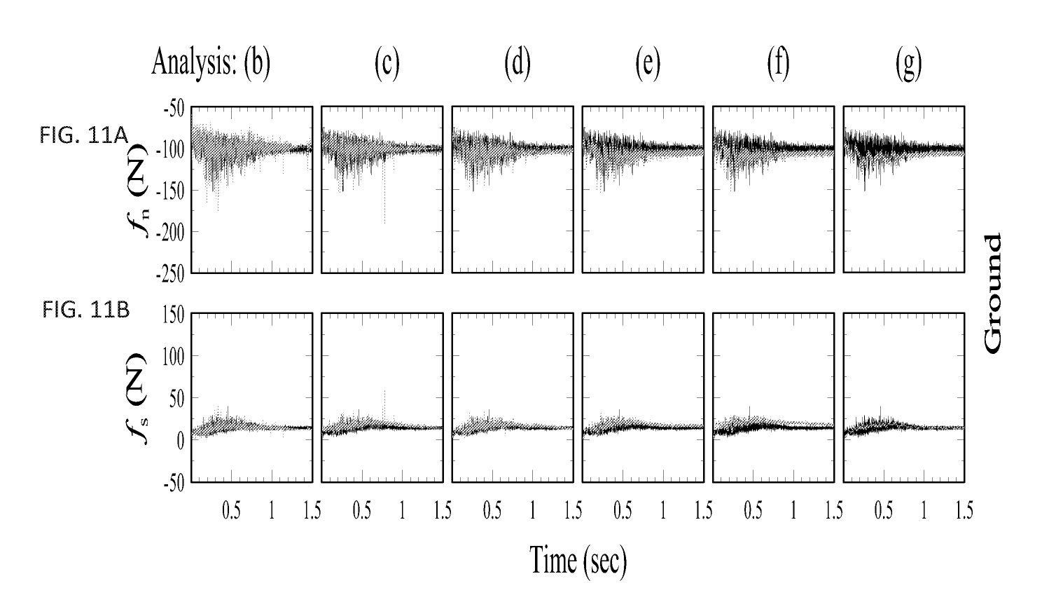

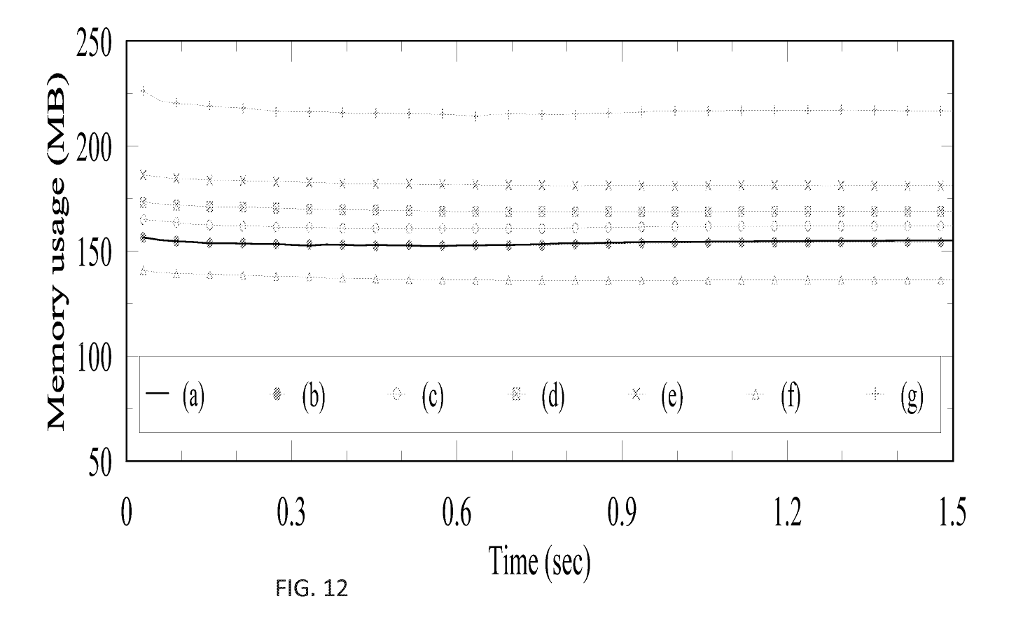

FIGS. 10A-10G and FIGS. 11A-11B compare the configurations and the contact forces on the ground with increase of the time step used. A similar trend is observed with 500 particles simulations, losing some geometric accuracy in the final configuration with use of the largest time step, but shows very good agreement on the contact forces. The figure also show the results of iDEM simulations at Δt_{iDEM}=Δt_{DEM}×100 with double- and single-precision arithmetic on a 32-bit machine. The single precision computation is promising, as it shows a good accuracy while saving memory.

Table 4 compares CPU time and speed-up for 5,000 particles flow.

TABLE 4
CPU time comparison for 5,000 particles flow

| | | | | CPU | |
|---|---|---|---|---|---|
| | | | CPU archi- | time | |
| | Δt (sec) | Precision | tecture | (min) | Speed-up |
| DEM | 5.03 × 10⁻⁶ | Double | 32-bit | 153.8 | 1 |
| iDEM | Δt_{DEM} × 1 | Double | 32-bit | 204.7 | 0.75 |
| | Δt_{DEM} × 10 | Double | 32-bit | 25.0 | 6.2 |
| | Δt_{DEM} × 50 | Double | 32-bit | 6.5 | 23.7 |
| | Δt_{DEM} × 100 | Double | 32-bit | 3.8 | 40.5 |
| | Δt_{DEM} × 100 | Single | 32-bit | 3.2 | 48.1 |
| | Δt_{DEM} × 500 | Double | 32-bit | 1.1 | 139.8 |

Although the speed-up shown in Table 4 is less than 500 particles simulations (compared to Table 3), the configuration at Δt_{iDEM}=Δt_{DEM}×500 in FIG. 10B is better (in terms of the height) than the corresponding configuration at Δt_{iDEM}=Δt_{DEM}×500 in FIG. 7B. This implies a larger time step than Δt_{DEM}×500 can be used to get a comparable speed-up with the 500 particles simulation.

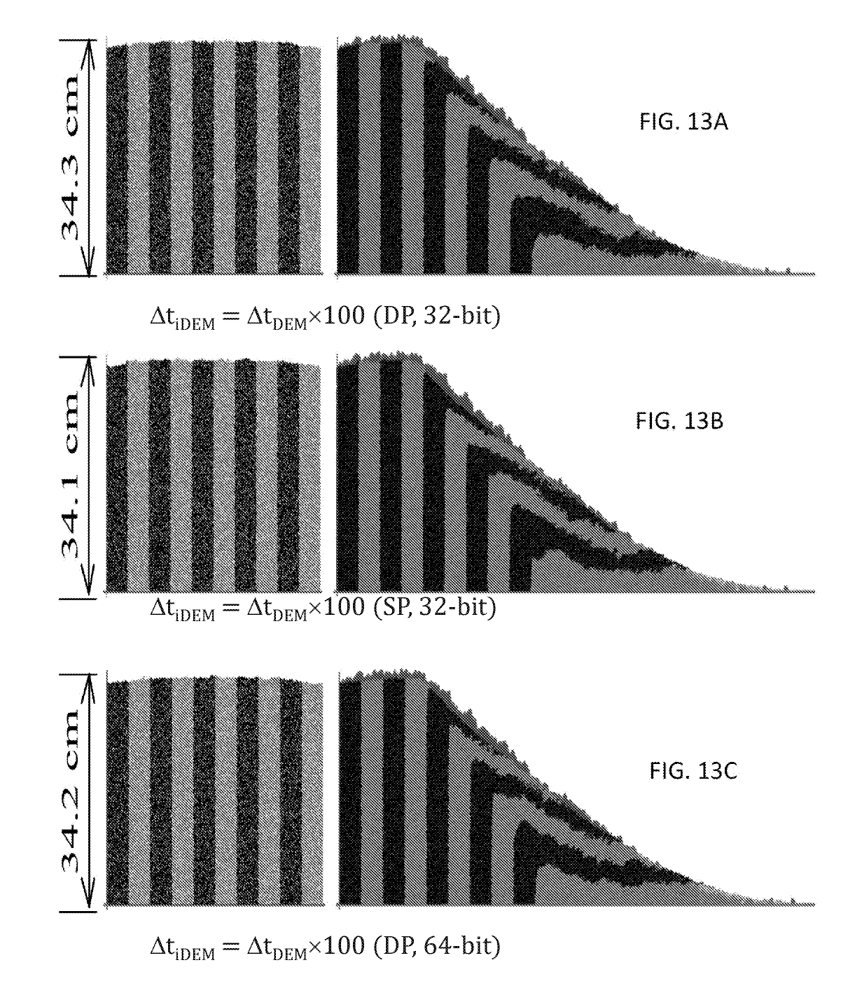

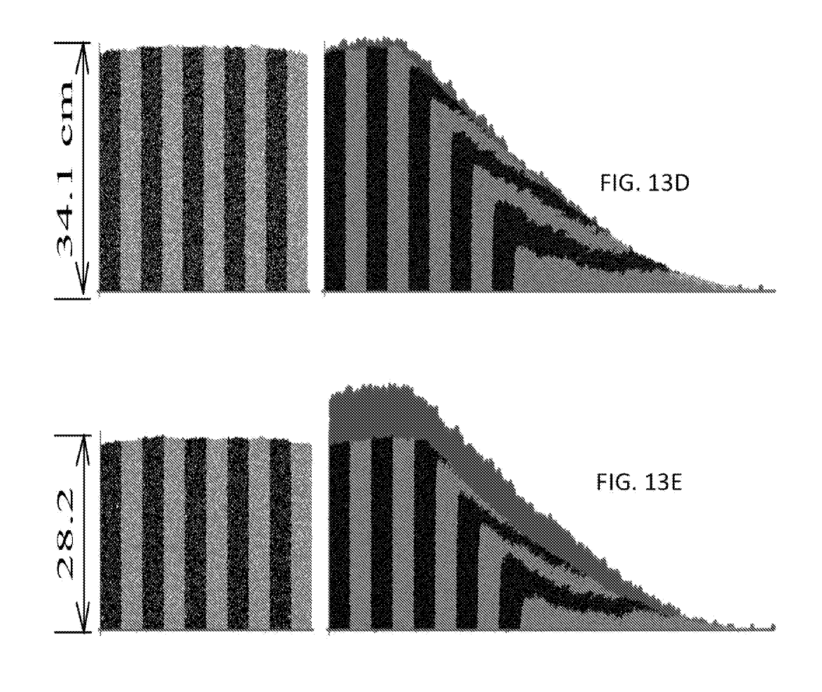

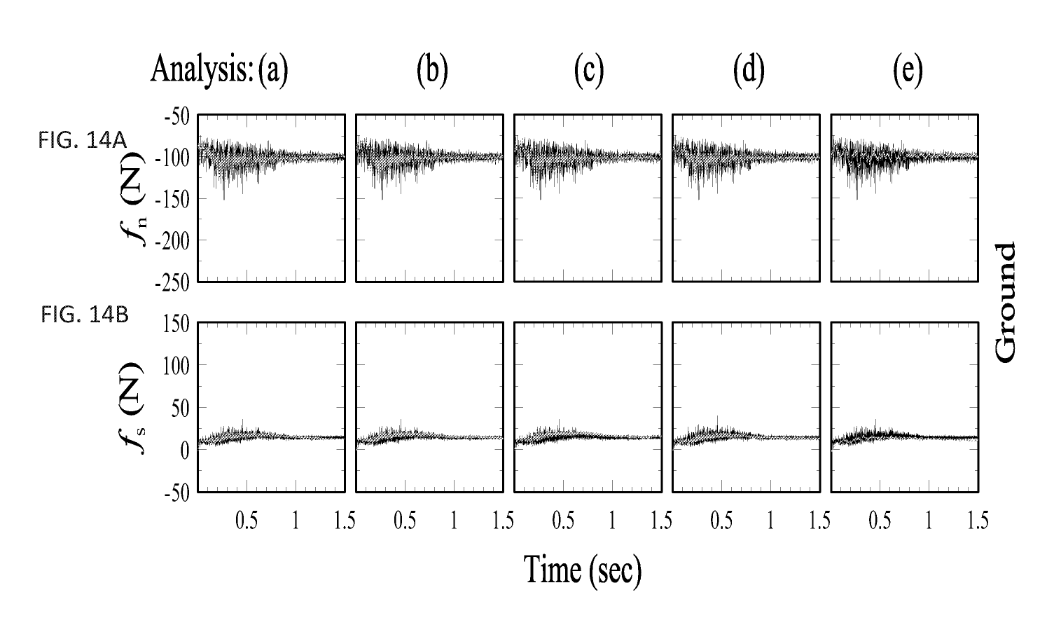

For the particles flows with 50,000 and 500,000 particles, DEM simulation was skipped, as it would require a significant CPU times as estimated in Table 5 and Table 6. Instead, iDEM simulation results will be compared with DEM simulation with 5,000 particles. FIG. 13 and FIG. 14 compare the DEM and iDEM simulation results of 50,000 particles flow at Δt_{iDEM}=Δt_{DEM}×100 and ×500, which are very comparable against each other.

Table 5 shows a CPU time comparison for 50,000 particles flow

TABLE 5
CPU time comparison for 50,000 particles flow

| | | | | CPU | |
|---|---|---|---|---|---|
| | | | CPU archi- | time | |
| | Δt (sec) | Precision | tecture | (hrs) | Speed-up |
| DEM | 8.94 × 10⁻⁷ | Double | 32-bit | 181.7* | 1* |
| iDEM | Δt_{DEM} × 100 | Double | 32-bit | 4.3 | 42.3 |
| | Δt_{DEM} × 100 | Single | 32-bit | 3.8 | 47.8 |
| | Δt_{DEM} × 100 | Double | 64-bit** | 2.9 | 62.7 |
| | Δt_{DEM} × 100 | Single | 64-bit** | 2.8 | 64.9 |
| | Δt_{DEM} × 500 | Double | 32-bit | 1.3 | 139.8 |

*Not performed, instead estimated based on the speed-up shown in Table 4
*Please note this machine also has a different processor performance from the 32-bit machine

Table 6 shows a CPU time comparison for 500,000 particles flow

TABLE 6
CPU time comparison for 500,000 particles flow
(Δt_{DEM} = 1.59 × 10⁻⁷ sec)

| | | | | CPU | |
|---|---|---|---|---|---|
| | | | CPU archi- | time | |
| | Δt (sec) | Precision | tecture | (days) | Speed-up |
| DEM | 1.59 × 10⁻⁷ | Double | 32-bit | 386.4* | 1* |
| iDEM | Δt_{DEM} × 200 | Single | 64-bit | 4.2 | 92.0 |
| | Δt_{DEM} × 500 | Single | 64-bit | 1.8 | 214.7 |

*Not performed, instead estimated based on the speed-up shown in Table 4 and Table 5

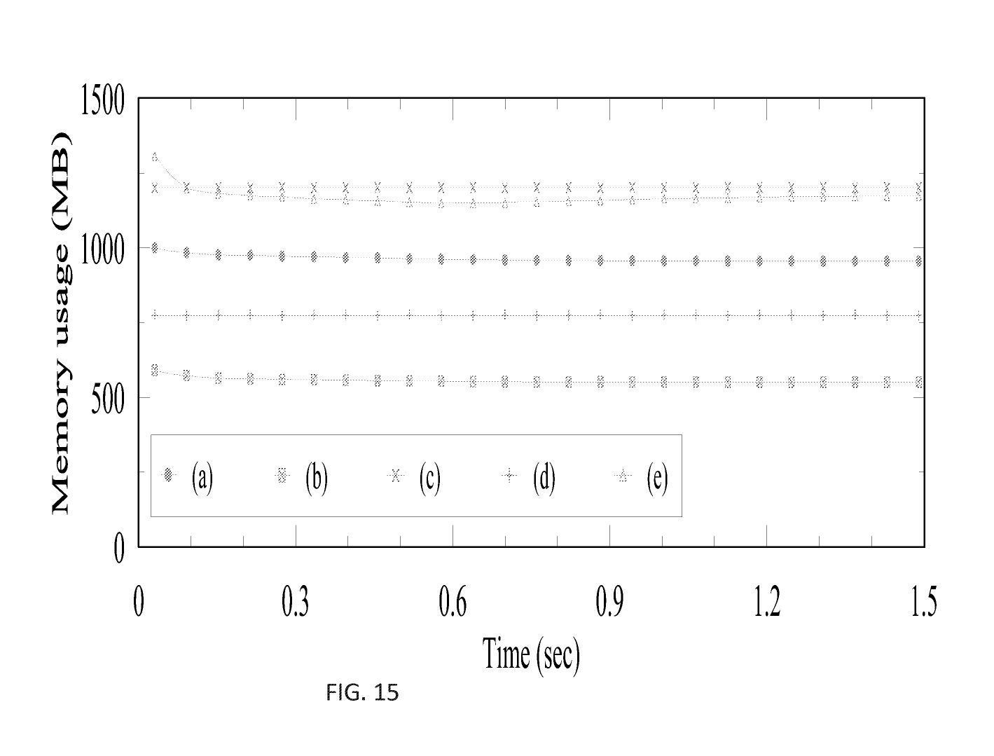

In FIGS. 13A-13E and FIGS. 14A-14B, iDEM simulations at Δt=Δt_{DEM}×100 are performed with double- and single-precision arithmetic on both 32- and 64-bit machines. The purpose of this simulation is to compare the memory usage and the code speed-up realized. The comparison of CPU-time between the 32-bit and 64-bit machine (in Table 5) is not the only difference in the 32-bit vs. 64-bit comparison. The CPU of the 32-bit machine is Intel Core 2 Extreme CPU Q6800 (2.93 Hz), and the 64-bit machine has Intel Core i7 2600 Processor (3.4 GHz). Therefore, there is considerable difference in the CPU performance. Table 5 shows there is a good speed-up in conducting the single precision simulation on 32-bit machine, opposed to the double-precision simulation. On the other hand, there is no much performance gap shown between single and double-precision simulation on 64-bit machine. However, the memory savings in 64-bit machine operation with the single precision is still apparent. The memory usage in FIG. 15 shows the simulation on 64-bit architecture spends more memory. This is possibly due to the width of the 64-bit memory address, as opposed to 32-bit wide memory address. However, 64-bit machine can use a larger size RAM, so such a memory usage is generally not an issue.

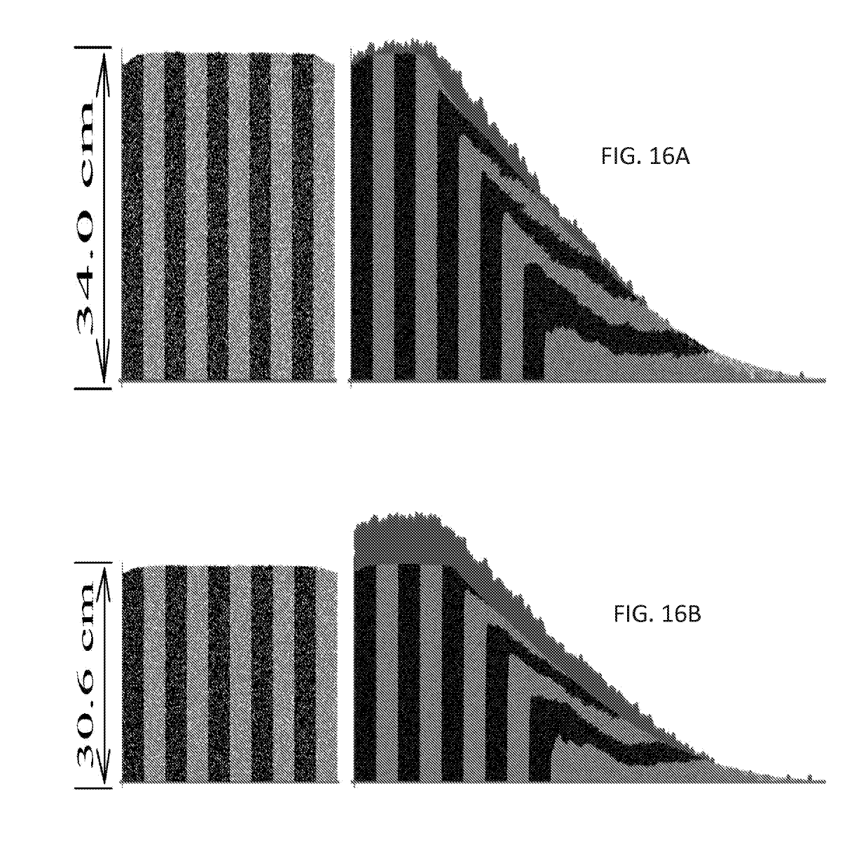

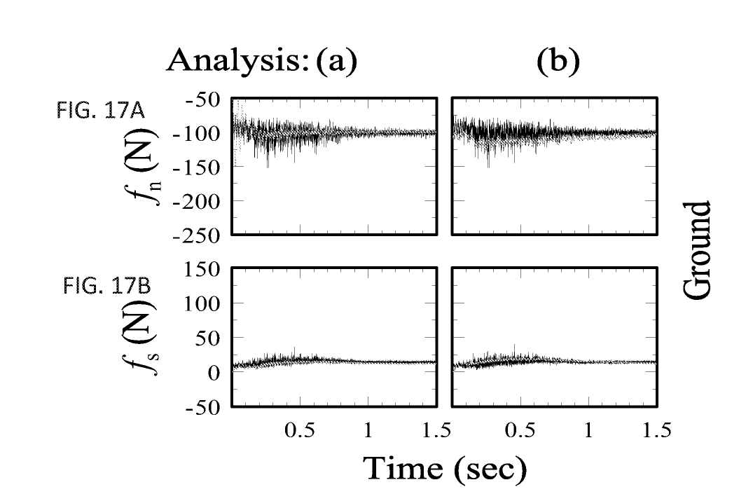

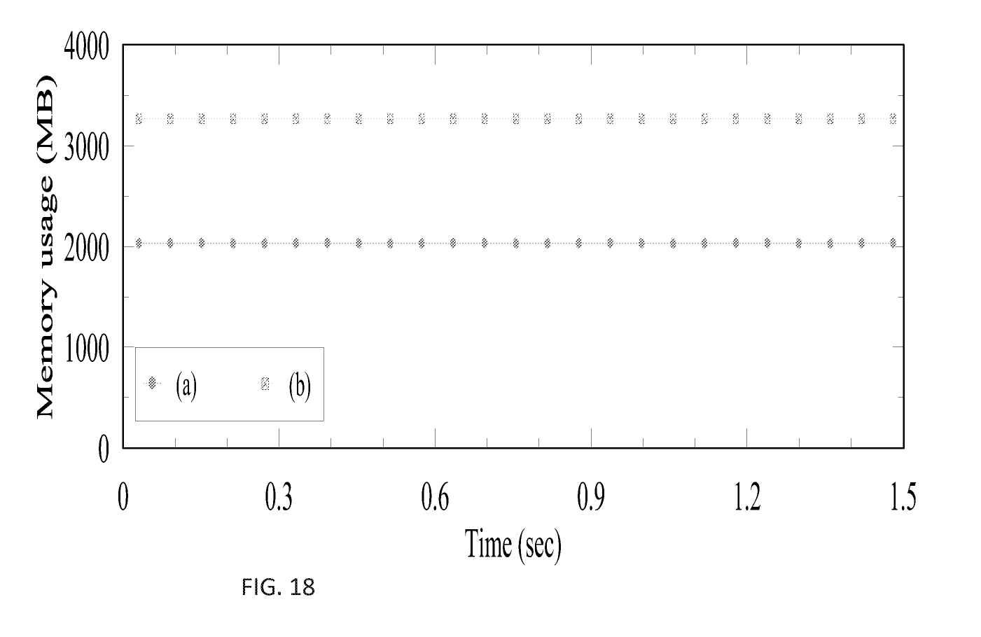

A 500,000 particles simulation has also been conducted. To decrease the CPU time, a particles flow simulation is performed at Δt_{iDEM}=Δt_{DEM}×200, while it was poured into the container at Δt_{iDEM}=Δt_{DEM}×100. Another particles flow simulation run at Δt_{DEM}=Δt_{DEM}×500. Both simulations run on 64-bit machine with single precision arithmetic. As there was a sudden time step change at the beginning of the iDEM simulation at Δt_{iDEM}=Δt_{DEM}×200, there are some minor oscillations shown at the beginning of the contact force measured (FIGS. 16A-16B). Other than that, the results shown in FIGS. 16A-16B and FIGS. 17A-17B are comparable to the corresponding DEM simulations for accuracy.

Generalized Contact Force Recovery

As shown by the preferred embodiments and simulation, the invention provides the ability to obtain contact force via an admissible function. By definition, collision impulse is the integration of contact force during the collision time, which can be represented by the following relationship:

ι=∫₀^{Δt}^{_{c}}f(t)dt (41)

The invention introduces an admissible function ƒ_{nc}(t) to get the normal contact force resembles the true normal contact force from collision impulse. The collision impulse is known from at the end of each time step in the impulse-based simulation (with collision impulse-velocity based formulation), and the function ƒ_{nc}(t) the can be molded to similarly satisfy the following relationship:

ιₙ=∫₀^{Δt}^{_{c}}ƒ_{nc}(t)dt (42)

In the preferred embodiments, a sinusoidal function is adopted to construct ƒ_{nc}(t) as follows, the complete normal contact force change during collision can be retrieved once either ƒₘₐₓ or Δt_{c} is determined.

$${l}_{n} = {\int }_{0}^{Δ {t}_{c}} {f}_{nc} ( t ) d t = {f}_{max} {\int }_{0}^{Δ {t}_{c}} {sin}^{2} ( \frac{π t}{Δ {t}_{c}} ) d t = {f}_{max} \frac{Δ {t}_{c}}{2} \qquad ( 43 )$$

ƒₘₐₓ is determined as follows:

ƒₘₐₓ=−\sqrt{k₁m_{col|n}}\check{v}_{rel|n} (44)

where k₁ is the normal contact stiffness, m_{col|n} is the collision mass, and \check{v}_{rel|n} is the approach velocity between bodies at the moment of collision. The normal contact stiffness k₁ needs to be calibrated (like contact force-acceleration based formulation), and m_{col|n} and \check{v}_{rel|n} can be obtained from the simulation.

Equation (44) has been derived from the principle of the conservation of mechanical energy with use of conceptual equivalence of coefficients of restitution considered in this document.

Once the normal contact force is found as above, the shear contact force can be easily obtained using Coulomb's friction law.

The above embodiments apply a two level search and shortest link method for neighbor search and contact detection. In other embodiments, general DEM neighbor search and contact detection methods (or broad and narrow phase detection in some computer graphics literatures) for polyhedral particles can also be used for the impulse-based simulation (Step 30 in FIG. 3).

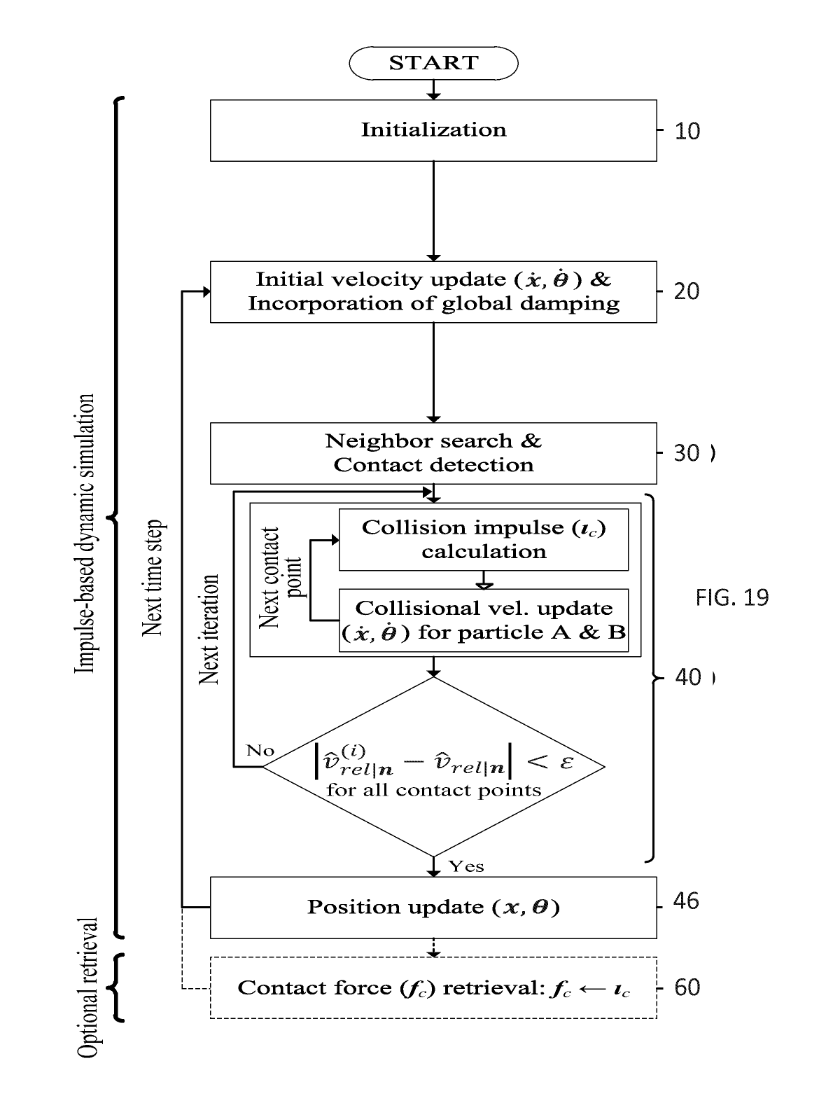

FIG. 19 is a flowchart that illustrates another preferred method of the invention for determining contact force change during collision in a multi-body system from collision impulse. The FIG. 19 method can use general DEM neighbor search and contact detection methods. The method is consistent with FIG. 3, and additional details for a preferred implementation have been added. Common reference numerals have been used to illustrate corresponding steps in FIGS. 3 and 19. For ease of reading and to avoid reference back to equations above, some equations and explanations are repeated in discussing the method of FIG. 19.

The detailed flowchart of FIG. 19 can be better understood with a restatement of the 2^{nd} order differential equations of motion for a rigid particle for motion update are shown in equations (45) and (46), each for translation and rotation.

### Equations of Motion (DEM):

M\ddot{x}+C_{M}\dot{x}=f=Σƒ_{c(k)}+ƒ_{b} (45)

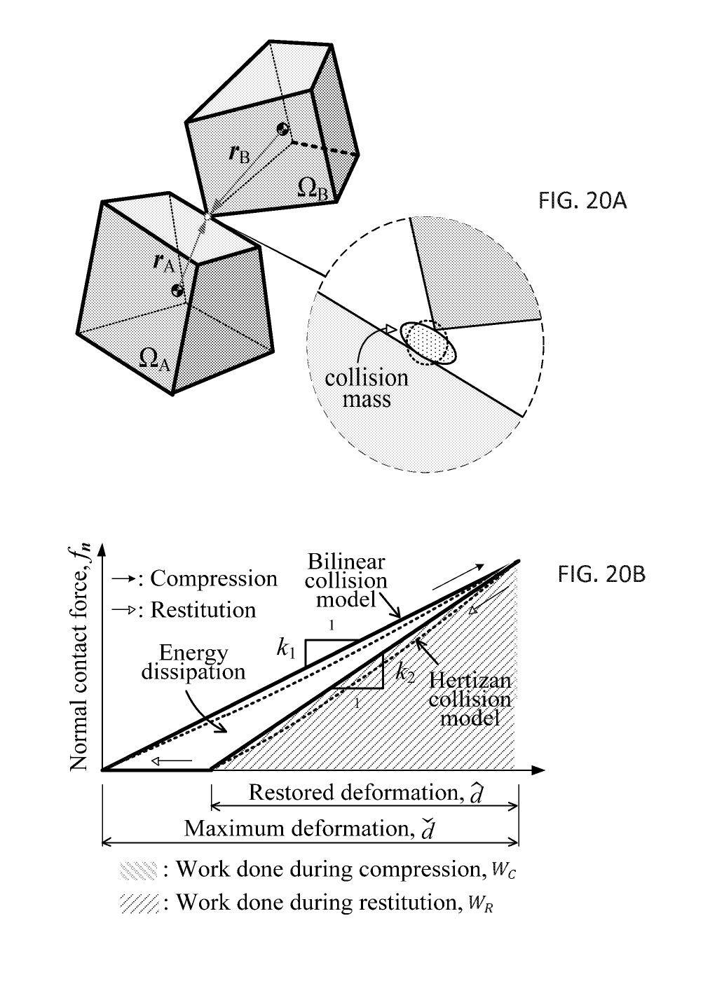

I\ddot{θ}+C₁\dot{θ}=τ=Σ(r₍ₖ₎×ƒ_{c(k)})+I\dot{θ}×\dot{θ} (46)

where M is the diagonal mass matrix, i.e., M=m1, in which 1 is the identity matrix. I is the moment of inertia tensor, and C_{M} and C_{I} are the global damping matrices. The position and orientation of the particle are shown as x and θ. The total force f acting on the particle can be decomposed into two terms: Σƒ_{c(k)}, the sum of contact forces on contact points k and ƒ_{b}, the body force. τ is the torque acting on the particle. Σ(r₍ₖ₎×ƒ_{c(k)}) is the resultant torque, r₍ₖ₎ is the vector from the particle's center of mass to the contact point as shown in FIG. 20A.

The equations of collision between two particles in DEM adopt the spring-damper model to calculate ƒ_{c(k)}, contact force at each contact:

### Equations of Collision (DEM):

$$\begin{matrix}{f}_{c ( k )} = {f}_{n} + {f}_{t} & ( 47 ) \\ {f}_{n} = {f}_{en} + {f}_{dn} = \overbrace{{k}_{n} {δ}_{n} + {k}_{nn} {δ}_{n}^{b}}^{{f}_{en}} + \overbrace{{β}_{d} {k}_{n} {v}_{rel \vert n}}^{{f}_{dn}} & ( 48 ) \\ {f}_{t} = {f}_{et} + {f}_{dt} = \underbrace{{f}_{et}^{old} + {k}_{t} {v}_{rel \vert t} Δ t}_{{f}_{et}} + \underbrace{{β}_{d} {k}_{t} {v}_{rel \vert t}}_{{f}_{dt}} & ( 49 )\end{matrix}$$

where ƒₙ and ƒₜ are the normal and tangential component of the contact force. ƒₑₙ and ƒₑₜ are the elastic components of the contact force, and ƒ_{dn} and ƒ_{dt} are the damping components. The normal contact stiffness parameters are shown as kₙ, kₙₙ, b, and the shear contact stiffness is kₜ. δₙ is the normal penetration distance. The relative velocity of the contact point vᵣₑₗ which is equal to v_{B}−v_{A}, where v_{Ω} is the velocity of a point in particle Ω, i.e., v_{Ω}=\dot{x}_{Ω}+\dot{θ}_{Ω}×r_{Ω}, and r_{Ω} is the vector from the mass center of particle Ω to the contact point. This is illustrated graphically in FIGS. 20A and 20B. The relative velocity to each normal and tangential direction is v_{rel|n} and v_{rel|t}. β_{d} is contact damping factor, which is equal to 2ξ_{c}/ω_{avg}; ξ_{c} is the contact damping ratio; ω_{avg} is the average natural frequency of the system. The magnitude of ƒₜ is limited by Coulomb's friction law:

∥ƒₜ∥≦μ∥ƒₙ∥ (50)

where μ is the friction coefficient (μ=tan(φ′_{μ})).

On the other hand, the impulse-based dynamic simulation employ the 1st order differential equations of motion shown in equations (51) and (52), which can be obtained from integration of equations (45) and (46) over time.

Equations of Motion (Impulse-Based Dynamic Simulation):

MΔ\dot{x}+C_{M}Δx=ι=Σι_{c(k)})+ƒ_{b}Δt (51)

IΔ\dot{θ}C_{I}Δθ=η=Σ(r₍ₖ₎×ι_{C(k)})+(I\dot{θ}×\dot{θ})Δt (52)

where Δ\dot{x} and Δ\dot{θ} are changes in the translational and angular velocity over a given Δt. Total (linear) impulse acting on the particle is t. The collision impulse on a contact point k is shown as ι_{c(k)}, which is the time integration of contact force over Δt. Likewise, for rotation, η is the total angular impulse.

Advantageously, the equations of collision in the impulse-based dynamic simulation do not require the spring-damper model of DEM. This can provide significant computational advantages. Consider two polyhedral particles A and B colliding at a single contact point as shown in FIG. 19A. The collision impulse ι_{c(k)} applied to the contact point can be calculated as shown in equations (53) to (57). The equations of collision can be determined using the impulse-momentum theorem with the concept of the relative velocity at a contact point.

### Equations of Collision (Impulse-Based Dynamic Simulation):

ι_{c(k)=ι}ₙ+ιₜ=ιₙn+ιₜt (53)

ιₙ=m_{col|n}Δv_{rel|n}=m_{col|nw}Δvᵣₑₗ·n=m_{col|n}(\hat{v}ᵣₑₗ−\check{v}ᵣₑₗ)·n=−m_{col|n}\check{v}_{rel|n}(Rₙ+1) (54)

ιₜ₌ₘ_{col|t}Δv_{rel|t}=m_{col|t}Δvᵣₑₗ·t=m_{col|t}(\hat{v}ᵣₑₗ−\check{v}ᵣₑₗ)·t=−m_{col|t}\check{v}_{rel|t}(Rₜ+1) (55)

m_{col|n}=1/[n^{T}(M_{A}⁻¹+M_{B}⁻¹−r_{A}^{x}I_{A}⁻¹r_{A}^{x}−r_{B}^{x}I_{B}⁻¹r_{B}^{x})n] (56)

m_{col|t}=1/[t^{T}(M_{A}⁻¹+M_{B}⁻¹r_{A}^{x}I_{A}⁻¹r_{A}^{x}−r_{B}^{x}I_{B}⁻¹r_{B}^{x})t] (57)

where ιₙ and ιₜ are the normal and tangential component of the collision impulse. n and t are the unit vectors for each normal and tangential direction. The change of relative velocity at the contact point is shown as Δvᵣₑₗ(=\hat{v}ᵣₑₗ−\check{v}ᵣₑₗ). \hat{v}ᵣₑₗ represents the separation velocity at the contact point, while \check{v}ᵣₑₗ is the approach velocity. m_{col|n} and m_{col|t} are the collision mass to each normal and tangential collision direction.

The collision mass is a mathematical artifact, which can be seen as the hypothetical mass of an infinitesimal deformable particle defined at the contact point between the two colliding particles, as shown in FIG. 19A. Each particle mass is m_{A} and m_{B}. Likewise, I_{A} and I_{B} are the moment of inertia tensors. The superscripts x in R_{A}^{x} and r_{B}^{x} are simply a matrix notation equivalent to vector cross product, i.e., r_{Ω}^{x}≡r_{Ω}x. As shown in equations (56) and (57), the collision mass is determined by the contact geometry and each particle's mass. Rₙ is the coefficient of normal restitution, and Rₜ is the coefficient of tangential restitution. These coefficients quantify the energy dissipation during collision to each normal and tangential direction, which are defined as the ratio of the relative velocities before and after the collision:

$$\begin{matrix}{R}_{n} = - \frac{{\hat{v}}_{rel} \cdot n}{{{v}^{⋁}}_{rel} \cdot n} = - \frac{{\hat{v}}_{rel \vert n}}{{{v}^{⋁}}_{rel \vert t}} & ( 58 ) \\ {R}_{t} = - \frac{{\hat{v}}_{rel} \cdot t}{{{v}^{⋁}}_{rel} \cdot t} = - \frac{{\hat{v}}_{rel \vert t}}{{{v}^{⋁}}_{rel \vert t}} & ( 59 )\end{matrix}$$

Rₙ typically ranges between 0 and 1 due to some energy dissipation, where Rₙ=0 represents a perfectly plastic collision while Rₙ=1 represents an elastic collision. Rₜ ranges between −1 and 1. Rₜ=−1 represents a perfectly smooth collision where the tangential relative velocity is conserved while Rₜ=1 represents a perfect slip reversal, which can occur for a collision of elastic gear wheels. The values of Rₙ and Rₜ can be calibrated for use in the simulation. Once determined, ιₙ and ιₜ can be calculated as shown in equation (54) and (55), where the magnitude of ιₜ is limited by Coulomb's friction law:

∥ιₜ∥≦μ∥ιₙν (60)

where μ=tan(φ′_{μ)}

Compared to the equations of collision for DEM in equations (47) to (49), the collision equations (53) to (57) of the impulse-based dynamic simulation do not explicitly account for contact damping. Instead, the coefficients of restitution equivalently represent the energy dissipation during the collision. The coefficient of normal restitution Rₙ is inversely proportional to the contact damping ratio ξ_{c}. Anagnostopoulos (“Pounding of buildings in series during earthquakes,” Earthquake Engineering & Structural Dynamics 16:443-456 (1988)) shows a relationship between Rₙ and ξ_{c}, in which Rₙ=1 corresponds to ξ_{c}=0 and Rₙ=0 corresponds to ξ_{c}=1:

$${ξ}_{c} = \frac{- ln {R}_{n}}{\sqrt{{π}^{2} + {( ln {R}_{n} )}^{2}}} \qquad ( 61 )$$

where ln Rₙ is natural logarithm of Rₙ.

As shown in equations of motion for DEM and the impulse-based dynamic simulation, force causes acceleration, while impulse directly changes velocity, so the time integration of the equations (51) and (52) does not require the acceleration update, in contrast to DEM. For this reason, a different numerical integrator is used in the impulse-based dynamic simulation. The integration scheme of DEM is shown in equations (62) and (63) for comparison with equations (64) and (65) used in the impulse-based dynamic simulation.

$$\begin{matrix}DEM \text{:} & {x}^{( t + 1 )} = {x}^{( t )} + {\dot{x}}^{( t )} Δ t + \frac{1}{2} {\ddot{x}}^{( t )} Δ {t}^{2} \\ & {θ}^{( t + 1 )} = {θ}^{( t )} + {\dot{θ}}^{( t )} Δ t + \frac{1}{2} {\ddot{θ}}^{( t )} Δ {t}^{2} ( 63 ) \\ Impulse \text{-} based & {x}^{( t + 1 )} = {x}^{( t )} + ( {\dot{x}}^{( t )} + Δ {\dot{x}}^{( t )} ) Δ t ( 64 ) \\ dynamic simulation \text{:} & {θ}^{( t + 1 )} = {θ}^{( t )} + ( {\dot{θ}}^{( t )} + Δ {\dot{θ}}^{( t )} ) Δ t ( 65 )\end{matrix} \qquad ( 62 )$$

The difference in the time integration methods appears in the last term.

DEM considers the second order term for acceleration at time step t for motion update, while the impulse-based dynamic simulation updates the motion via the linear change of velocities. The numerical integration scheme of DEM, known as the central difference time integration, is a second order accurate approximation of Taylor series. Therefore, equations (62) and (63) consider a “tangent” change of velocity to find the position at t+1, compared to equations (64) and (65) take account of the “secant” change of velocity from t to t+1. This integration scheme is known as the symplectic Euler method, in which the “secant” changes (Δ\dot{x}^{(t)}, Δ\dot{θ}^{(t)} are directly obtained from the collision impulse.

DEM is only conditionally stable. The time step size has to be equal to or less than a critical time step size determined by the highest natural frequency of the discrete system in equation (66).

Δt≦2/ωₘₐₓ=2/\sqrt{kₙ/mₘᵢₙ} (66)

where mₘᵢₙ is the minimum particle mass and kₙ is the max normal contact stiffness in the discrete system.

The method of FIG. 19 can be consider to have two separate phases. A first phase is impulse-based dynamic simulation. A second phase conducts contact force retrieval.

The first phase corresponds to collision impulse calculation within step 40 in FIG. 19. The impulse algorithm can be implemented in with available physics engines for impulse-based dynamic simulation such as Box2D and Bullet Physics. A second phase corresponds to 60 in FIG. 19 and subsequent updates, which is a new force retrieval formulation, provided by the invention. The force retrieval algorithm can be implemented with the impulse-based method within the framework of the polyhedral DEM code, such as BLOKS3D (see, Zhao D, Nezami E G, Hashash Y M A, Ghaboussi J. Three-dimensional discrete element simulation for granular materials. Engineering Computations 23 pp. 749-770 (2006)). The new implementation can be referred to as iBLOKS3D, as it considers the collision impulse model. Example parameter inputs are listed in Table 7.

TABLE 7
Example DEM and iDEM modeling parameters and values.
Common parameters

| | | |
|---|---|---|
| Gₛ | Specific gravity of solids | 2.6 |
| φ_{μ}′ | Inter-particle friction angle | 27 deg. |
| α_{d} | Global damping factor | 0 |

| DEM | | | iDEM | | |
|---|---|---|---|---|---|
| ξ_{c} | Contact damping | 0.1 | Rₙ | Coefficient of normal | 0.73 |
| | ratio | | | restitution | |
| — | — | — | Rₜ | Coefficient of tangential | 0 |
| | | | | restitution | |
| kₙ | Normal contact | 260 | k₁^{β} | Contact stiffness for force | 260 |
| | stiffness | kN/m | | retrieval | kN/m |
| kₜ | Shear contact | 204 | — | — | — |
| | stiffness | kN/m | | | |

The preferred iBLOKS3D code randomly determines the particle orientation and the size for each particle position within the constraint of a grain size distribution. The particle velocities are set to zero. The particle shapes are defined in the user-defined library, from which the code also randomly selects a shape to generate. The particle mass and moment of inertia are calculated based on Gs, particle volume and shape. The boundaries' mass and moment of inertia are set to infinity.

In step 20, there is an initial velocity update and incorporation of global damping. The motion integration the preferred embodiment in FIG. 19 can be accomplished by integrating ƒ_{b}Δt and (I\dot{θ}×\dot{θ})Δt from the right side of equations of motion (51) and (52).

Δ\dot{x}=M⁻¹ƒ_{b}Δt (67)

Δ\dot{θ}=I⁻¹(I\dot{θ}×\dot{θ})Δt (68)

The new velocity of the particle is then calculated as follows:

\dot{x}:=\dot{x}+Δ\dot{x} (69)

\dot{θ}:=\dot{θ}+Δ\dot{θ} (70)

where := is the operator that denotes value update.

The global damping, if used, is then integrated, which is shown on the left hand side in the equations of motion (51) and (52). The velocity change due to global damping can be obtained as follows:

Δ\dot{x}=M⁻¹C_{M}Δx=M⁻¹C_{M}\dot{x}Δt=α_{d}\dot{x}Δt (71)

Δ\dot{θ}=I⁻¹C_{I}Δθ=I⁻¹C_{I}\dot{θ}Δt=α_{d}\dot{θ}Δt (72)

where C_{M}=α_{d}M and C_{I}=α_{d}I ; α_{d}=2ξ_{g}ω_{avg} is the viscous global damping factor; ξ_{g} is the global damping ratio; ω_{avg} is the average natural frequency of the system.

The new velocity from the global damping can then be updated as follows:

\dot{x}:=\dot{x}(1−α_{d}Δt) (73)

\dot{θ}:=\dot{θ}(1−α_{d}Δt) (74)

where 0≦1−α_{d}Δt≦1

In step 30, a neighbor search and contact detection is conducted. The preferred iDEM of FIG. 19 performs the neighbor search to make a list of close pairs and then conducts the precise contact detection on each identified particle pair. General DEM neighbor search and contact detection methods can be adopted for iDEM. A preferred embodiment uses a Two Level Search scheme (Zhao D, et al., Three-dimensional discrete element simulation for granular materials. Engineering Computations 23 pp. 749-770 (2006)) for the neighbor search and the Shortest Link Method (Nezami E G, Hashash Y M A, Zhao D, Ghaboussi J., “Shortest link method for contact detection in discrete element method,” International Journal for Numerical and Analytical Methods in Geomechanics 30 783-801 (2006)) for the pairwise contact detection, which are the resident algorithms of BLOKS3D code. Particle penetration, if any, is computed at this stage.

In step 40, collision impulse calculation and collisional velocity update is conducted. The collision terms shown on the right hand side in the equations of motion (51) and (52) are integrated. The collision solver of the preferred embodiment considers each contact point between two particles A and B, and calculates the collision impulse ι_{c(k)} as shown in the equations of collision (53) to (57). The solver calculates ιₙ first, and then ιₜ to limit the magnitude of ιₜ via Coulomb's friction law shown in equation (60). For each calculated ι_{c(k)}, the velocity change for the two particles can be obtained as follows:

ι_{c(k)}=ι_{B}=−ι_{A} (75)

Δ\dot{x}_{Ω}=M^{Ω}⁻¹ι_{Ω} (76)

Δ\dot{θ}_{Ω}=I_{Ω}⁻¹(r_{Ω}×ι_{Ω}) (77)

where Ω=A, B. ι_{A} and ι_{B} are the collision impulse applied to Particle A and B. Note the minus in front of ι_{A}, as the applied impulse is equal in the magnitude but opposite in the direction of ι_{B}.

The velocities for the particles are subsequently updated as follows:

\dot{x}_{Ω}:=\dot{x}_{Ω}+Δ\dot{x}_{Ω} (78)

\dot{θ}_{Ω}:=\dot{θ}_{Ω}+Δ\dot{θ}_{Ω} (79)

The collision impulse calculation from equations (53) to (57) and the velocity update in equation (75) to (79) are iteratively calculated for all contact points identified between two particles. The iteration is repeated until a specified collision law defined by the coefficient of restitution is numerically satisfied for all contact points, or the iteration reaches a specified maximum number of iterations. In a preferred embodiment, the following convergence criterion is applied whereby the normal separation velocities at every contact point in the system are within the numerical tolerance (ε) of the target:

|\hat{v}_{rel|n}⁽ⁱ⁾−\hat{v}_{rel|n}|<ε (80)

where \hat{v}_{rel|n}⁽ⁱ⁾ is the separation velocity updated at iteration i and \hat{v}_{rel|n} is the target obtained from the coefficient of normal restitution Rₙ in equation (58).

The calculated collision impulse is stored for use as the initial impulse estimate at the next time step to enhance convergence. The stored collision impulse can also be used to retrieve contact force in step 60.

The collision solver operation 40 of FIG. 19, like that of FIG. 3, does not consider an explicit non-penetration constraint. Instead, it operates on the velocity constraint between particles. A position correction technique can be used to correct for penetration errors:

$${\tilde{v}}_{rel \vert n} = \frac{{d}_{p}}{Δ t} \qquad ( 81 )$$

where dₚ is the penetration distance at a contact point, computed during neighbor search and contact detection, and Δt is the time step size. \tilde{v}_{rel|n} represents an additional velocity required to move the particles apart. A fraction of \tilde{v}_{rel|n} can be added to \hat{v}_{rel|n} in equation (58) so that an additional normal impulse is accounted for during collision:

\hat{v}_{rel|n}=−\check{v}_{rel|n}Rₙ+\tilde{v}_{rel|n} (82)

As discussed above, this can yield particles that move apart suddenly under circumstances in which significant penetrations exist in the granular system. Nonetheless, experiments demonstrate excellent agreement with much slower and computationally expensive DEM systems for many types of granular systems.

A position update 46 for each particle is made with the final velocities from the collision solver operation 40. The position and orientation vectors are updated with the velocities:

x:=x+\dot{x}Δt (83)

θ:=θ+\dot{θ}Δt (84)

The velocities \dot{x} and \dot{θ} in the equations above are equivalent to (\dot{x}^{(t)+Δ\dot{x}}^{(t)}) and (\dot{θ}^{(t)}+Δ\dot{θ}^{(t)}) in equations (64) and (65).

The FIG. 19 method also computes contact forces needed for engineering applications, but does so by retrieving the forces from the collision impulse in step 60. Impulse-based simulators can greatly increase code speed while maintaining physical plausibility and method of FIG. 19 provides retrieval of the contact force from the impulse-based simulation with reasonable fidelity, as demonstrated by experimental comparisons to DEM methods.

The preferred method accounts for two categories of contact: resting contacts and dynamic contacts. Criterion to determine the type of contact is related to whether the particles are separating in terms of velocity:

|\hat{v}_{rel|n}|>ε (85)

where \hat{v}_{rel|n} is the separation velocity after the collision solver; E is a numerical tolerance close to zero.

Resting contact: Resting contact refers to the condition in which particles are stationary and in contact. There is no additional external force or perturbation. The retrieved contact force ƒ_{nc}(t) is therefore assumed to be constant over Δt, iDEM calculation time step, and can be found as follows:

$${f}_{nc} ( t ) = \frac{{l}_{n}}{Δ t} \qquad ( 86 )$$

where ιₙ is the computed normal collision impulse after the position update 46. The shear contact force ƒ_{tc}(t) can be similarly found as:

$${f}_{tc} ( t ) = \frac{‖ {l}_{t} ‖}{Δ t} \qquad ( 87 )$$

where ιₜ is the computed tangential collision impulse.

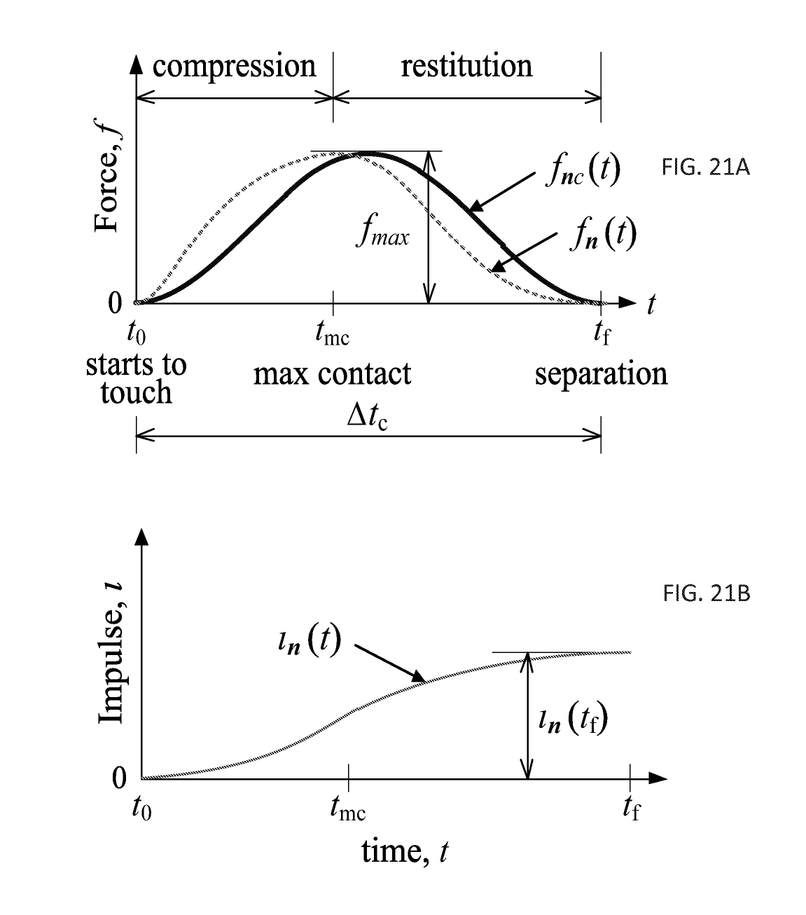

Dynamic contact occurs when particles experience a change of force via collision, as shown FIGS. 21A and 21B. Two colliding particles first go through a compression period, in which the normal contact force ƒₙ(t) increases until the colliding particles experience the maximum compression at the contact point, then followed by a restitution period, in which the normal contact force is gradually reduced until separation of the particles occurs. The collision impulse ιₙ(t) increases with time and reaches its maximum at the start of separation t_{f}.

The normal contact force is retrieved from the collision impulse ιₙ(t_{f}), being computed to move from current time step to next time step. The preferred method of FIG. 19 provides a functional form to define the shape of contact force change, maximum normal contact force ƒₘₐₓ and collision period Δt_{c} of the function to enable the force retrieval.

A sine-squared function is utilized as the admissible function and is provided in equation (23) above for ƒ_{nc}(t), it resembles the shape of ƒₙ(t), and is repeated here for ease of reference:

$${f}_{nc} ( t ) = {f}_{max} {sin}^{2} ( \frac{π t}{Δ {t}_{c}} ) \text{:} 0 \leq t \leq Δ {t}_{c} \qquad ( 88 )$$

Using this admissible function simplifies the relationship between ιₙ(t_{f}) and ƒₘₐₓ (or Δt_{c}), as defined on equation (24) and repeated for ease of reference:

$${l}_{n} ( {t}_{f} ) = {\int }_{0}^{Δ {t}_{c}} {f}_{nc} ( t ) d t = {f}_{max} {\int }_{0}^{Δ {t}_{c}} {sin}^{2} ( \frac{π t}{Δ {t}_{c}} ) d t = \frac{{f}_{max}}{2} Δ {t}_{c} \qquad ( 89 )$$

The maximum normal contact force ƒₘₐₓ is determined from stiffness k₁ and maximum deformation d of the hypothetical collision mass at the contact point shown in FIG. 20A. The remaining portions of contact force determination is closely related to that presented above in equations (25)-(44), but the following explanation provides artisans additional insight to construction of the admissible function for application of preferred embodiments of the invention and variations thereof:

ƒₘₐₓ=k₁\check{d} (90)

Impulse-based dynamic simulation provides only mass and velocity, but conservation of mechanical energy can relate change of kinetic energy ΔKE (of mass and velocity) to the change of strain energy ΔSE (of stiffness and deformation), each of which represents the energy loss for a dynamic contact.

ΔKE=−ΔSE (91)

ΔKE for the normal collision is the net work done by the normal contact force applied during the collision period. For an elastic collision, \hat{v}_{rel|n} is equal to \check{v}_{rel|n} with no energy loss, thus ΔKE=0, but for a typical collision, \hat{v}_{rel|n} is smaller than \check{v}_{rel|n}, so ΔKE<0.

$$Δ KE = \frac{1}{2} {m}_{col \vert n} ( {\hat{v}}_{rel \vert n}^{2} - {{v}^{⋁}}_{rel \vert n}^{2} ) = \frac{1}{2} {m}_{col \vert n} {{v}^{⋁}}_{rel \vert n}^{2} ( {R}_{n}^{2} - 1 ) \qquad ( 92 )$$

where m_{col|n} is the collision mass; \hat{v}_{rel|n} represents the separation velocity and \check{v}_{rel|n} is the approach velocity, all to the normal collision direction; Rₙ is the coefficient of normal restitution.

Formulation of ΔSE during a collision requires a normal contact force-deformation relationship. A bilinear collision model of Walton and Braun is represented in FIG. 20A, and has a linear loading stiffness k₁ less steep than k₂ for unloading. The maximum deformation of the hypothetical collision mass is \check{d}, and \hat{d} represents the restored deformation during the restitution phase. The energy dissipation during collision is equivalently shown as the plastic deformation, i.e., the area between the compression and restitution curves.:

$$Δ SE = \frac{1}{2} {k}_{1} {{d}^{⋁}}^{2} - \frac{1}{2} {k}_{2} {\hat{d}}^{2} \qquad ( 93 )$$

Walton and Braun also proposed a quadratic coefficient of restitution R_{WB} based on the bilinear collision model, with the concept of material damping ξ used for a force-displacement hysteresis loop. The damping ξ is taken as the ratio of cross-hatched triangle areas in FIG. 20B, and then R_{WB}² is defined as:

$$ξ = \frac{{W}_{R}}{{W}_{C}} = {R}_{WB}^{2} = \frac{{k}_{1}}{{k}_{2}} = \frac{\hat{d}}{{d}^{⋁}} \qquad ( 94 )$$

The graphical determination naturally leads to the simple relationship between k₁ and k₂, and also \hat{d} and \check{d}, as shown in equation (94). Equation (93) then can be simplified in terms of the restitution R_{WB}:

$$Δ SE = \frac{1}{2} {k}_{1} {{d}^{⋁}}^{2} ( 1 - {R}_{WB}^{2} ) \qquad ( 95 )$$

Substituting equations (92) and (95) into equation (91) leads to the following:

$${d}^{⋁} = - \sqrt{\frac{{m}_{col \vert n}}{{k}_{1}} β} {{v}^{⋁}}_{rel \vert n} \qquad ( 96 )$$

where β=(Rₙ²−1)/(R_{WB}²−1).

Therefore, ƒₘₐₓ can be found, using equation (90):

ƒₘₐₓ₌ₖ₁\check{d}=−\sqrt{k₁βm_{col|n}}\check{v}_{rel|n} (97)

The collision mass m_{col|n} and the approach velocity \check{v}_{rel|n} are known at the moment of collision. The normal contact stiffness kv1^{β}(=k₁β) can be calibrated as done in DEM.

Now that ƒₘₐₓ is known, it is simple to get the collision period Δt_{c}:

$$Δ {t}_{c} = 2 \frac{{l}_{n} ( {t}_{f} )}{{f}_{max}} \qquad ( 98 )$$

In case there is more than one contact point between the colliding particles, average values of velocity and collision mass for all contact points can be used for \check{v}_{rel|n} and m_{col|n} in equation (97), and the total collision impulse over the contact points is used for ιₙ(t_{f}) in equation (98).

The shear force function ƒ_{ιc}(t) can be assumed to have the same shape and collision period Δt_{c} as the normal force function ƒ_{nc}(t). The maximum shear force can then be computed as:

$${f}_{t\_max} = 2 \frac{‖ {l}_{t} ( {t}_{f} ) ‖}{Δ {t}_{c}} \qquad ( 99 )$$

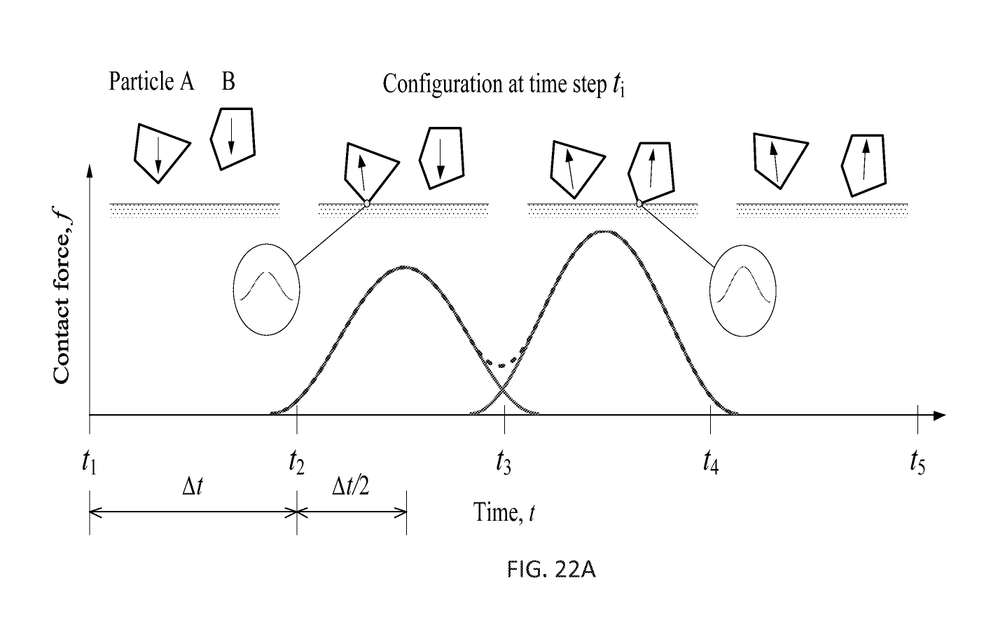

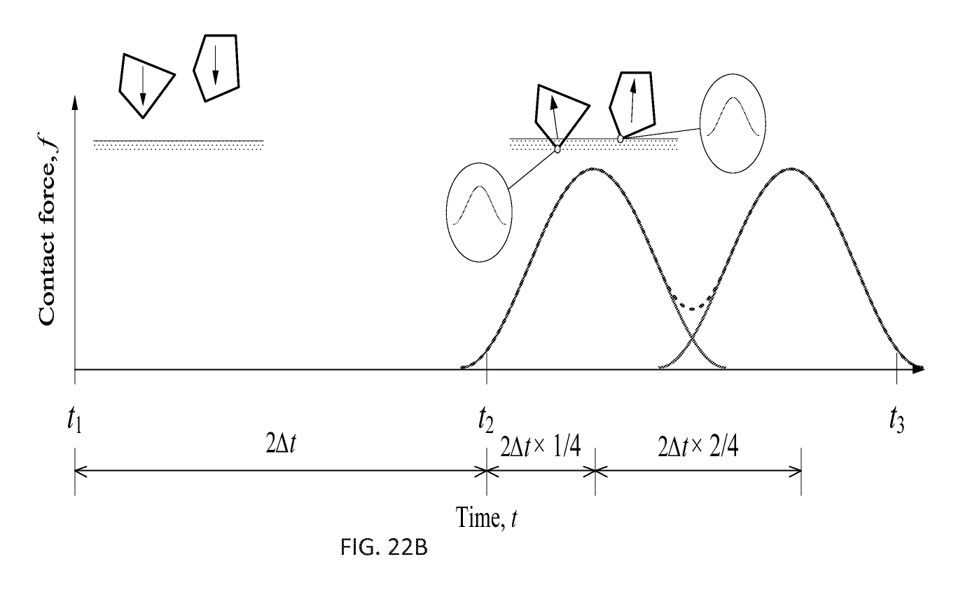

The retrieved contact force for each collision is then collected to form a time series of contact force. A simulation of two particles being dropped on the ground with a time step size of Δt is illustrated in FIG. 22A. Particle A is initially at a lower height than Particle B, so A hits the ground first at time step t₂, and then B hits at time step t₃ while Particle A bounces off. For the earlier collision, the contact force was retrieved from the collision between A and the ground, and then recorded on the time series such that the center is located in the middle of t₂ and t₃, i.e., t₂+Δt/2. Another contact force is retrieved for the collision involving Particle B, and then also placed accordingly. Suppose both collision durations are larger than Δt as shown in the figure, there is overlap of the contact forces near t₃. In this case, summations are then made for the contact forces overlap with respect to time. The final contact force retrieved is shown as a dotted line in the same figure.

The simulation shown in FIG. 22B uses the same initial condition as FIG. 21A except for the time step size, in which twice of Δt is considered. Due to the larger time step size, both particles hit the ground together, for each of which the contact force is retrieved. There is no time lag between the two collisions in FIG. 22B. The time series of contact forces is presented as if there was a time lag of the collisions by uniformly placing the retrieved contact forces over the time. This approximation is appropriate for large scale granular materials simulations because the collisions are likely to be distributed over time. The following equation can be used to place the center of retrieved contact force in a given time step:

$$t = {t}_{i} + Δ t ( \frac{2 c + 1}{2 {N}_{c}} ) \qquad ( 100 )$$

where tᵢ is the simulation time at the beginning of current time step i. N_{c} is the total number of collisions made on the body of interest to retrieve the contact force, e.g., the ground in FIGS. 22A and 22B, and cε{0, 1, 2, . . . N_{c}−1}.

If there is any resting contact forces, they can be simply added up as a constant value without using the sine-squared function.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An engine for simulating a multi-body system, the engine including code for:
determining collision impulse over a time period for a plurality of colliding bodies in the system;
determining an admissible function from the collision impulse that resembles true contact force from the collision impulse;
recovering force from the admissible function.

2. The engine of claim 1, wherein said determining introduces an admissible function ƒ_{nc}(t) to get the normal contact force that resembles the true normal contact force ƒₙ(t) from collision impulse by determining collision impulse at the end of the collision period Δt_{c}, and molding the function ƒ_{nc}(t) to satisfy the following relationship:
ιₙ−∫₀^{Δt}_{^{c}}ƒ_{nc}(t)dt (41)
and then adopting a sinusoidal function to construct ƒ_{nc}(t) from a known Δr_{c} as follows, the complete contact force change during collision can be retrieved once either ƒₘₐₓ or Δt_{c} is determined:
$${l}_{n} = {\int }_{0}^{Δ {t}_{c}} {f}_{nc} ( t ) d t = {f}_{max} {\int }_{0}^{Δ {t}_{c}} {sin}^{2} ( \frac{π t}{Δ {t}_{c}} ) d t = {f}_{max} \frac{Δ {t}_{c}}{2} \qquad ( 42 )$$
ƒₘₐₓ is determined as follows:
$${f}_{max} = - \sqrt{{k}_{1} {m}_{col \vert n}} {{v}^{⋁}}_{rel \vert n} \qquad ( 43 )$$
, where k₁ is the normal contact stiffness, m_{col|n} is an effective mass for the collision, and \check{v}_{rel|n} is the approach velocity between bodies at the moment of collision.

3. The engine of claim 2, wherein said recovering force is electively applied to adjust simulation times.

4. The engine of claim 2, wherein said recovering force recovers the complete set of forces between the colliding bodies.

5. The engine of claim 1, wherein said determining collision impulse comprises:
initializing by defining initial particle positions, orientations, sizes, shapes and properties;
updating the position of bodies;
conducting a neighbor search and detecting contact;
calculating collision impulse and updating velocity of bodies; and
iterating said updating, conducting and calculating to determine complete collision impulse information for all colliding bodies in the system.

6. The engine of claim 5, wherein said iterating is conducted until a specified collision law is satisfied for all contact points in a given time step.

7. The engine of claim 6, wherein the specified collision law is satisfied when the normal separation velocity of colliding bodies is within the numerical tolerance of a target separation velocity to the normal collision direction.

8. The engine of claim 7, wherein the numerical tolerance (ε) of the target separation velocity to the normal collision direction:
∥\hat{v}_{rel|n}⁽ⁱ⁾−\hat{v}_{rel|n}∥<ε (1)
where \hat{v}_{rel|n} is the separation velocity updated at an iteration 1 and \hat{v}_{rel|n} is the theoretical target obtained from Newton's impact law:
$${R}_{c} = - \frac{{\hat{v}}_{rel \vert n}}{{{v}^{⋁}}_{rel \vert n}} \qquad ( 2 )$$

9. The engine of claim 5, wherein collision impulse information is calculated for each normal (ιₙ) and tangential (ιₜ) direction of collision with reference to m_{col|n} and m_{col|t} as the collision mass, and Δv_{rel|n} and Δv_{rel|t} as the change of relative velocity for a contact point to each direction.

10. The engine of claim 5, wherein said updating position includes position correction to implicitly account for penetration of colliding bodies by applying a predetermined normal impulse.

11. The engine of claim 5, wherein an energy dissipation factor that is a fraction of 1 is applied to determine impulse during a collision of two bodies and the energy dissipation factor is derived from physical tests of representative bodies for the multi-body system.

12. The engine of claim 11, wherein the admissible function comprises a sine squared function that relates at least one of collision duration and collision magnitude with collision impulse to determine contact force.

13. The engine of claim 11, wherein the admissible function relates collision duration to normal contact force via a work energy theorem to the normal direction of collision.

14. The engine of claim 11, further comprising determination of a shear contact force by approximating shear contact force to have a shape that corresponds to normal contact force and is bound by the normal contact force.

15. The engine of claim 1, wherein the colliding bodies comprise granular particle materials.

16. The engine of claim 15, wherein the code is run on one or a plurality of graphics processing units.

17. The engine of claim 15, wherein the code is run on one or a plurality of workstations, personal computers, or portable computers.

18. An engine for simulating a multi-body system, the engine including code for:
means for determining collision impulse between colliding bodies in the system; and
means for deriving contact force from collision impulse received from said means for determining.

19. The engine of claim 18, wherein said means for determining calculates a 1st order time integration of motion to calculate collision impulse and velocity and said means for deriving recovers higher-order engineering details lost during the 1^{st} order time integration via admissible functions that approximate detailed collisions.
